(19) United States
(12) Patent Application Publication
(10) Pub. No.: US 2025/0239619 A1
(43) Pub. Date: Jul. 24, 2025

(54) FLEXIBLE BATTERY AND ELECTRONIC DEVICE

(71) Applicant: SEMICONDUCTOR ENERGY LABORATORY CO., LTD., Atsugi-shi, Kanagawa-ken (JP)

(72) Inventors: Tetsuya KAKEHATA, Isehara, Kanagawa (JP); Kazutaka KURIKI, Ebina, Kanagawa (JP); Shunpei YAMAZAKI, Setagaya, Tokyo (JP)

(21) Appl. No.: 18/703,458

(22) PCT Filed: Oct. 12, 2022
(86) PCT No.: PCT/IB2022/059765

§ 371 Date: Apr. 22, 2024

(30) Foreign Application Priority Data
Oct. 26, 2021 (JP) 2021-174987

(51) Int. Cl. H01M 4/66; H01M 4/02; H01M 4/13; H01M 4/70; H01M 50/466; H01M 50/469

(52) U.S. Cl. CPC H01M 4/663; H01M 4/13; H01M 4/70; H01M 50/466; H01M 50/469; H01M 2004/021

(57) ABSTRACT

A flexible battery with high safety or durability is provided. The flexible battery includes a negative electrode and a positive electrode. The negative electrode includes a first material containing carbon, a first current collector, and a negative electrode active material formed in the first current collector. The first material containing carbon wraps the first current collector and the negative electrode active material. The positive electrode includes a second material containing carbon, a second current collector, and a positive electrode active material formed in the second current collector. The second material containing carbon wraps the second current collector and the positive electrode active material.

### TECHNICAL FIELD

One embodiment of the present invention relates to a battery cell and an electronic device. Specifically, one embodiment of the present invention relates to a flexible battery and an electronic device including the flexible battery.

Note that one embodiment of the present invention is not limited to the above technical field, and relates to a semiconductor device, a display device, a light-emitting device, a recording device, a driving method thereof, or a manufacturing method thereof. That is, the technical field of one embodiment of the invention disclosed in this specification and the like relates to an object, a method, or a manufacturing method.

### BACKGROUND ART

In recent years, wearable devices such as smartwatches or head-mounted displays have been actively developed. The appearance of wearable devices often includes curved portions so as to conform to the human body and ensure a comfortable fit; it has been proposed that secondary batteries mounted on the wearable devices also include curved portions (see Patent Document 1).

Furthermore, mobile devices such as smartphones and tablets use a flexible display held by a housing, so that the flexible display can follow the moving of the housing (see Patent Document 2).

Graphene has attracted great attention because of its excellent conductivity and the like, and a large-scale production method and the like have been searched. As described in Non-Patent Document 1, a compound obtained by reduction of graphene oxide (GO) is referred to as reduced GO (rGO) in some cases and the physical property thereof has attracted attention.

### REFERENCE

### Patent Document

[Patent Document 1] Japanese Published Patent Application No. 2016-110640
[Patent Document 2] Japanese Published Patent Application No. 2016-075884

### Non-Patent Document

[Non-Patent Document 1]A. Bagri et al., “Structural evolution during the reduction of chemically derived graphene oxide”, NATURE CHEMISTRY, vol. 2, 2010, pp. 581-587.

### SUMMARY OF THE INVENTION

### Problems to be Solved by the Invention

In the field of secondary batteries, where safety is paramount, fixing has been considered important. According to Patent Document 1 above, when external force changes the shape of a smartwatch, a secondary battery preferably has flexibility; however, the change in shape in wearing the smartwatch is small and the secondary battery is fixed to the smartwatch together with a plate. In the description of Patent Document 2 above, a lithium-ion battery is mounted and fixed to a position overlapping with a housing that does not move.

In view of the above description, an object of one embodiment of the present invention is to provide a flexible battery that can follow the moving of a housing.

Note that the description of these objects does not preclude the existence of other objects. One embodiment of the present invention does not need to achieve all the objects. Note that other objects can be derived from the description of the specification, the drawings, and the claims (referred to as the specification and the like).

### Means for Solving the Problems

In view of the above description, one embodiment of the present invention is a flexible battery including a negative electrode and a positive electrode. The negative electrode includes a first material containing carbon, a first current collector, and a negative electrode active material formed in the first current collector. The first material containing carbon wraps the first current collector and the negative electrode active material. The positive electrode includes a second material containing carbon, a second current collector, and a positive electrode active material formed in the second current collector. The second material containing carbon wraps the second current collector and the positive electrode active material.

Another embodiment of the present invention is a flexible battery including a negative electrode and a positive electrode. The negative electrode includes a first material containing carbon, a first current collector, a second current collector positioned in an opening portion of the first current collector, and a negative electrode active material formed in the first current collector and the second current collector. The first material containing carbon wraps the first current collector, the second current collector, and the negative electrode active material. The positive electrode includes a second material containing carbon, a third current collector, a fourth current collector positioned in an opening portion of the third current collector, and a positive electrode active material formed in the third current collector and the fourth current collector. The second material containing carbon wraps the third current collector, the fourth current collector, and the positive electrode active material.

In another embodiment of the present invention, the second current collector and the fourth current collector are preferably provided to overlap with a curved region.

In another embodiment of the present invention, each of the first material containing carbon and the second material containing carbon preferably has a bag-like shape or a cylindrical shape.

In another embodiment of the present invention, each of the first material containing carbon and the second material containing carbon preferably includes a graphene compound.

In another embodiment of the present invention, the graphene compound is preferably graphene oxide.

In another embodiment of the present invention, the graphene compound is preferably reduced graphene oxide.

In another embodiment of the present invention, each of the first material containing carbon and the second material containing carbon preferably includes graphene.

In another embodiment of the present invention, each of the first material containing carbon and the second material containing carbon preferably includes carbon fiber.

In another embodiment of the present invention, a separator is preferably provided between the negative electrode and the positive electrode.

In another embodiment of the present invention, the separator preferably has a bag-like shape or a cylindrical shape.

In another embodiment of the present invention, a separator positioned between the negative electrode and the positive electrode is preferably not provided.

In another embodiment of the present invention, the positive electrode preferably has a smaller area than the negative electrode.

In another embodiment of the present invention, the median diameter (D50) of the negative electrode active material or the positive electrode active material is preferably greater than or equal to 10 nm and less than or equal to 30 μm.

In another embodiment of the present invention, the positive electrode active material preferably includes a secondary particle and the median diameter (D50) of a primary particle included in the secondary particle is preferably greater than or equal to 10 nm and less than or equal to 1 μm.

Another embodiment of the present invention is an electronic device including a flexible battery.

### Effect of the Invention

According to one embodiment of the present invention, a flexible battery that can follow the movement of a housing can be provided.

Note that the description of these effects does not preclude the existence of other effects. One embodiment of the present invention does not need to have all of these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. TA and FIG. 1B are cross-sectional views illustrating a flexible battery of one embodiment of the present invention.

FIG. 2A and FIG. 2B are cross-sectional views each illustrating a flexible battery of one embodiment of the present invention.

FIG. 3A and FIG. 3B are cross-sectional views each illustrating a flexible battery of one embodiment of the present invention.

FIG. 4A and FIG. 4B are a cross-sectional view and a top view illustrating a negative electrode of one embodiment of the present invention.

FIG. 5A to FIG. 5C are cross-sectional views illustrating an active material layer and the like of a negative electrode of one embodiment of the present invention.

FIG. 6A and FIG. 6B are diagrams each illustrating a graphene compound of one embodiment of the present invention.

FIG. 7A and FIG. 7B are diagrams illustrating a spray-drying apparatus.

FIG. 8A and FIG. 8B are cross-sectional views illustrating an active material layer and the like of a negative electrode of one embodiment of the present invention.

FIG. 9A and FIG. 9B are a cross-sectional view and a top view illustrating a positive electrode of one embodiment of the present invention.

FIG. 10 is a cross-sectional view illustrating a negative electrode of one embodiment of the present invention.

FIG. 11 is a cross-sectional view illustrating a negative electrode of one embodiment of the present invention.

FIG. 12 is a cross-sectional view illustrating a negative electrode of one embodiment of the present invention.

FIG. 13 is a cross-sectional view illustrating a flexible battery of one embodiment of the present invention.

FIG. 14A to FIG. 14C are a cross-sectional view or a top view illustrating a flexible battery of one embodiment of the present invention.

FIG. 15A to FIG. 15D are cross-sectional views each illustrating a negative electrode of one embodiment of the present invention.

FIG. 16A to FIG. 16D are cross-sectional views each illustrating a negative electrode of one embodiment of the present invention.

FIG. 17A to FIG. 17D are cross-sectional views each illustrating a negative electrode of one embodiment of the present invention.

FIG. 18A and FIG. 18B are cross-sectional views each illustrating a flexible battery of one embodiment of the present invention.

FIG. 19A to FIG. 19E are cross-sectional views and the like illustrating an exterior body of one embodiment of the present invention.

FIG. 20A to FIG. 20C are cross-sectional views and the like illustrating an exterior body of one embodiment of the present invention.

FIG. 21A and FIG. 21B are cross-sectional views and the like illustrating an exterior body of one embodiment of the present invention.

FIG. 22A to FIG. 22E are cross-sectional views and the like illustrating an exterior body of one embodiment of the present invention.

FIG. 23A to FIG. 23E are cross-sectional views and the like illustrating an exterior body of one embodiment of the present invention.

FIG. 24 is a cross-sectional view illustrating an exterior body of one embodiment of the present invention.

FIG. 25A and FIG. 25B are top views each illustrating an exterior body of one embodiment of the present invention.

FIG. 26A to FIG. 26C are top views each illustrating an exterior body of one embodiment of the present invention.

FIG. 27A to FIG. 27E are top views, a cross-sectional view, and the like illustrating a flexible battery of one embodiment of the present invention.

FIG. 28A and FIG. 28B are cross-sectional views illustrating an exterior body of one embodiment of the present invention.

FIG. 29 is a flowchart showing a formation method of a positive electrode active material by a coprecipitation method of one embodiment of the present invention.

FIG. 30A to FIG. 30C are flowcharts showing a formation method of a positive electrode active material by a solid phase method of one embodiment of the present invention.

FIG. 31A and FIG. 31B are diagrams illustrating an electronic device of one embodiment of the present invention.

FIG. 32A and FIG. 32B are diagrams illustrating an electronic device of one embodiment of the present invention.

FIG. 33A to FIG. 33D are diagrams each illustrating an electronic device of one embodiment of the present invention.

FIG. 34A to FIG. 34D are diagrams each illustrating an electronic device of one embodiment of the present invention.

FIG. 35A to FIG. 35C are diagrams illustrating an electronic device of one embodiment of the present invention.

FIG. 36A to FIG. 36C are diagrams illustrating an electronic device of one embodiment of the present invention.

### MODE FOR CARRYING OUT THE INVENTION

Embodiment examples for carrying out the present invention will be described below with reference to the drawings and the like. Note that the present invention should not be interpreted as being limited to the embodiment examples given below. Embodiments for carrying out the invention can be changed unless it deviates from the spirit of the present invention.

In this specification and the like, a flexible battery is a movable battery and specifically refers to a battery that is held by a housing and capable of following the movement of the housing.

### Embodiment 1

In this embodiment, a flexible battery 100 of one embodiment of the present invention will be described. The flexible battery 100 is a battery that can follow a housing when the housing moves; for example, a lithium-ion battery (a lithium-ion secondary battery) can be used as the battery. The flexible battery 100 of one embodiment of the present invention can be in a curved state.

### Structure Example 1

A cross-sectional view in FIG. 1A illustrates the flexible battery 100 that is in a flat state. A cross-sectional view in FIG. 1B illustrates the flexible battery 100 that is in a curved state. The flexible battery 100 of one embodiment of the present invention can be repeatedly set in the flat state illustrated in FIG. 1A and the curved state illustrated in FIG. 1B. The flexible battery 100 in the curved state as in FIG. 1B has a curved portion, and thus is referred to as a battery including a curved portion, for example. Note that the curved position can be at the center portion of the flexible battery 100 but may be at any position other than the center portion.

As illustrated in FIG. 1A and FIG. 1B, the flexible battery 100 includes a negative electrode 101 and a positive electrode 131, and has a structure in which the negative electrode 101 and the positive electrode 131 are stacked (sometimes referred to as a stacked-layer structure or an electrode with a stacked-layer structure). Although the number of stacked negative electrodes 101 may be equal to the number of stacked positive electrodes 131 in the flexible battery 100, the number of stacked negative electrodes 101 may be different from the number of stacked positive electrodes 131. For example, the number of stacked negative electrodes 101 may be larger than the number of stacked positive electrodes 131.

FIG. 1A illustrates the case where the area of the negative electrode 101 is equal to that of the positive electrode 131. Although the area of the negative electrode 101 and the area of the positive electrode 131 may be equal to each other in the flexible battery 100, the area of the negative electrode 101 may be different from the area of the positive electrode 131.

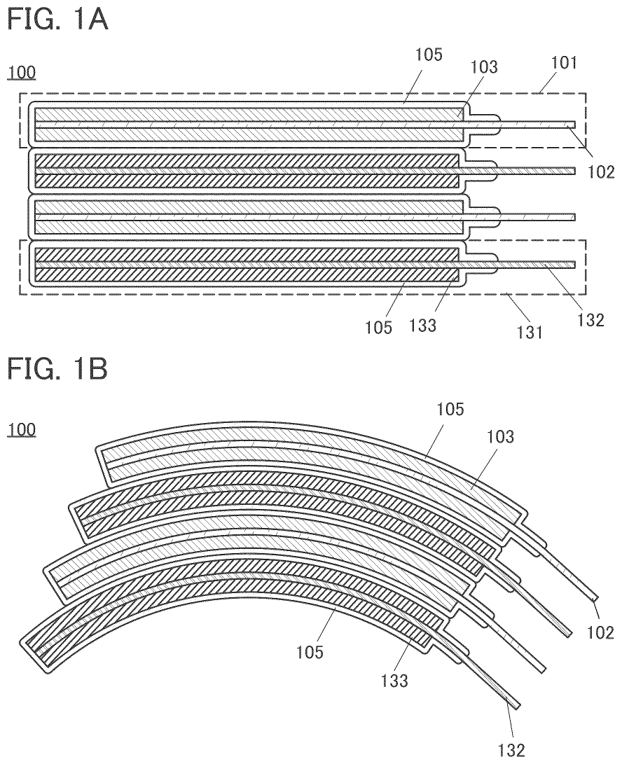

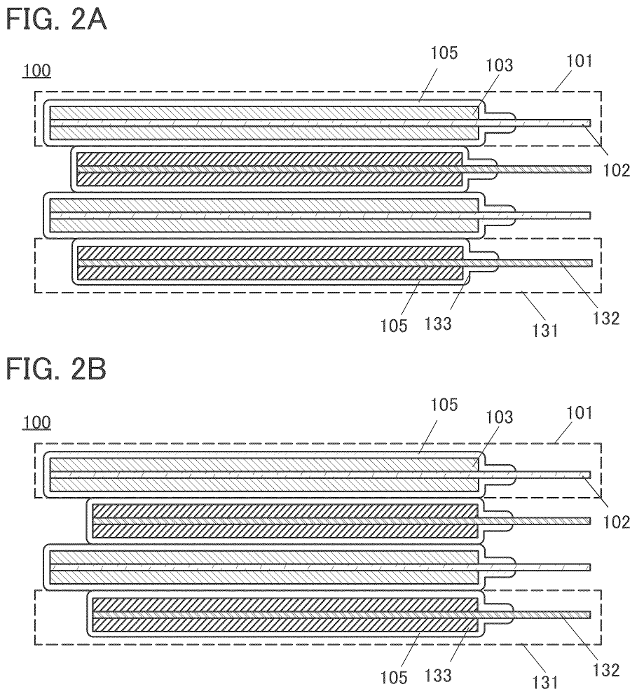

FIG. 2A illustrates a structure in which the area of the negative electrode 101 is larger than that of the positive electrode 131. FIG. 2B illustrates a structure in which the area of the negative electrode 101 is larger than the area of the positive electrode 131 and an end of the negative electrode 101 is aligned with an end of the positive electrode 131. That is, in the flexible battery 100 of one embodiment of the present invention, ends of the negative electrode 101 and the positive electrode 131 may be aligned with each other or they are not necessarily aligned with each other. Note that current collectors of the negative electrodes 101 that protrude from the ends are welded to each other, and furthermore, current collectors of the positive electrodes 131 that protrude from the ends are welded to each other. The structure in which the area of the negative electrode 101 is larger than the area of the positive electrode 131 as in FIG. 2A and FIG. 2B can reduce the area of the positive electrode 131 that does not face the negative electrode 101 when the flexible battery 100 is in the curved state.

When the flexible battery 100 is bent with one end being fixed as illustrated in FIG. 1B, while the stacked-layer structure of the negative electrode 101 and the positive electrode 131 is maintained, an end portion of the negative electrode 101 and an end portion of the positive electrode 131 are shifted from each other in the other end of the flexible battery 100. Also in FIG. 2A and FIG. 2B, when the flexible battery 100 is bent with one end being fixed, while the stacked-layer structure of the negative electrode 101 and the positive electrode 131 is maintained, an end portion of the negative electrode 101 and an end portion of the positive electrode 131 are shifted from each other in the other end of the flexible battery 100.

That is, in the case where the flat state illustrated in FIG. 1A and the curved state illustrated in FIG. 1B are repeated, the negative electrode 101 and the positive electrode 131 move in accordance with the shift of the position. The same applies to the case where the flat state and the curved state illustrated in FIG. 2A and FIG. 2B are repeated. The moving with the shift causes the adjacent negative electrode 101 and positive electrode 131 to rub against each other, generating friction in some cases.

In the flexible battery 100 of one embodiment of the present invention, a material containing carbon 105 is positioned at least between the adjacent negative electrode 101 and positive electrode 131 so as to reduce friction between the adjacent negative electrode 101 and positive electrode 131. Specifically, the flexible battery 100 of one embodiment of the present invention has a structure in which an active material layer in the negative electrode 101 or an active material layer in the positive electrode 131 is wrapped by the material containing carbon 105. When any of the active material layers is wrapped by the material containing carbon 105, friction between the negative electrode 101 and the positive electrode 131 can be reduced. The flexible battery 100 of one embodiment of the present invention preferably has a structure in which the active material layers in the negative electrode 101 and the positive electrode 131 are wrapped by the material containing carbon 105. The flexible battery 100 including the material containing carbon 105 can form a favorable electron conduction path even with a small amount of conductive material.

A graphene compound, graphene, or carbon fiber can be used as the material containing carbon 105; the aforementioned friction in moving can be inhibited when a graphene compound, graphene, or carbon fiber is only attached to the active material layer. The graphene compound and the like will be described later. Note that the material containing carbon 105 can exhibit conductivity when it is a carbon material or can exhibit an insulating property depending on the proportion of contained oxygen or the like, for example.

The negative electrode 101 includes a current collector 102 (sometimes referred to as a negative electrode current collector) and an active material layer 103 (sometimes referred to as a negative electrode active material layer). The positive electrode 131 includes a current collector 132 (sometimes referred to as a positive electrode current collector) and an active material layer 133 (sometimes referred to as a positive electrode active material layer). The current collectors may be denoted with ordinal numbers in order to be distinguished from each other.

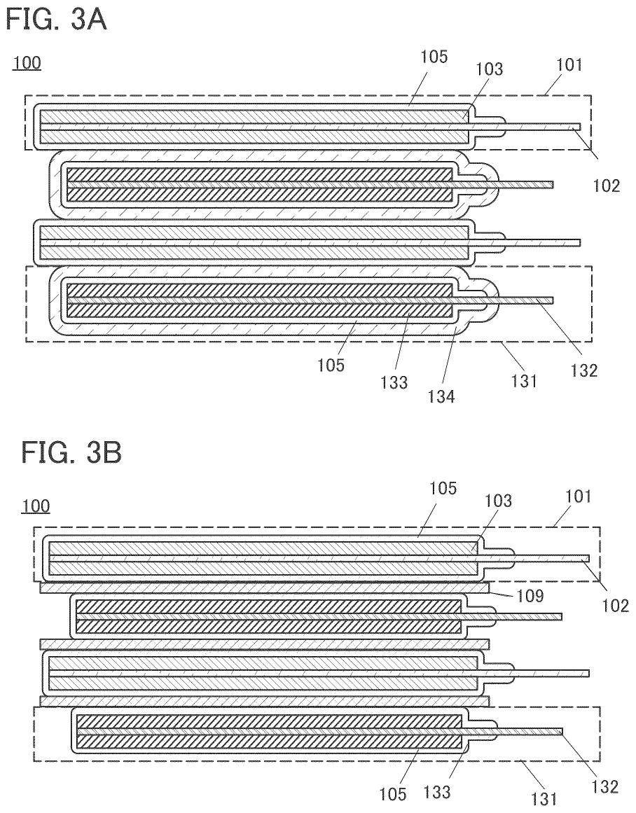

In the case where the material containing carbon 105 exhibits conductivity, the flexible battery 100 may include a separator. FIG. 3A illustrates the flexible battery 100 including a separator 134, which is not included in FIG. 1A to FIG. 2B. The separator 134 preferably has a bag-like shape or a cylindrical shape; in the positive electrode 131 illustrated in FIG. 3A, the active material layer 133 is held in the separator 134. The separator 134 having a bag-like shape or a cylindrical shape prevents the positive electrode 131 from protruding from the separator 134, providing a flexible battery with high safety or durability.

Note that the electrode held in the separator 134 preferably has a small area; in FIG. 3A, the positive electrode 131 is held in the separator 134 because the positive electrode 131 has a smaller area than the negative electrode 101 as in FIG. 2A or FIG. 2B. It is needless to say that the negative electrode 101 may be held in the separator 134.

FIG. 3B illustrates the flexible battery 100 including a sheet-like separator 109, which is different from that in FIG. 3A. The sheet-like separator 109 allows a flexible battery with high safety or reliability to be provided.

As described above, a separator is provided in the flexible battery 100 depending on the conductivity of the material containing carbon 105.

The material containing carbon 105 preferably exhibits an insulating property, in which case the material containing carbon 105 serves as a separator and a separator does not need to be provided in the flexible battery 100.

### <Negative Electrode>

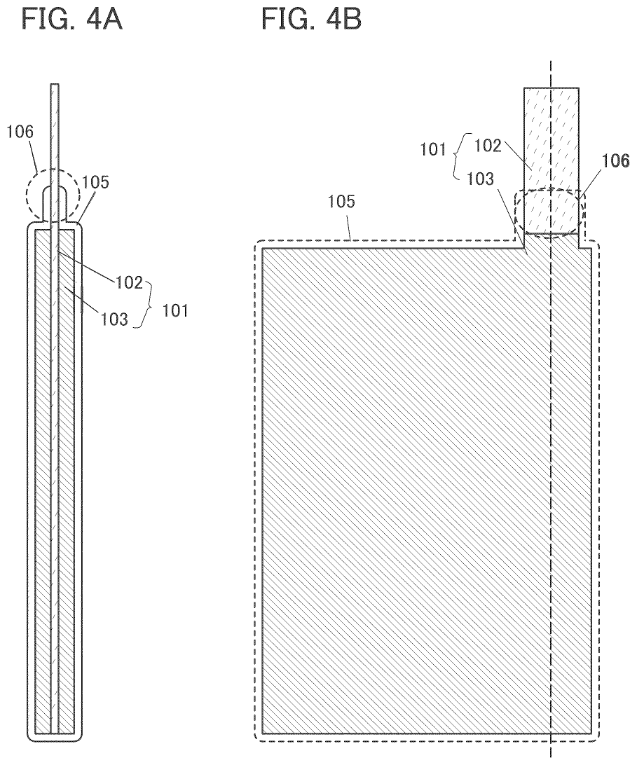

The structure of the negative electrode 101 is described. FIG. 4A is a cross-sectional view of the negative electrode 101, and FIG. 4B is atop view of the negative electrode 101. The cross-sectional view in FIG. 4A corresponds to a cross section in a position along a dotted line in FIG. 4B.

The negative electrode 101 includes the current collector 102 and the active material layer 103. As illustrated in FIG. 4A, the active material layer 103 is preferably formed on two surfaces (one surface and the other surface) of the current collector 102. A structure in which the active material layer 103 is formed on two surfaces is referred to as a double-side forming structure or a double-side coating structure. Although not illustrated in FIG. 4A, the active material layer 103 may be formed on either one surface or the other surface of the current collector 102. A structure in which the active material layer 103 is formed on one surface is referred to as a single-side forming structure or a single-side coating structure.

As illustrated in FIG. 1A to FIG. 4B, the current collector 102 and the active material layer 103 are wrapped by the material containing carbon 105 in the negative electrode 101. In other words, the material containing carbon 105 wraps the current collector 102 and the active material layer 103. In the flexible battery 100 of one embodiment of the present invention with such a structure including the material containing carbon 105, the material containing carbon 105 serves as what is called a cushioning material that reduces friction when the flat state in FIG. 1A, FIG. 2A to FIG. 3B, or the like and the curved state in FIG. 1B are repeated; thus, the flexible battery 100 can easily move and has high safety or durability. The material containing carbon 105 is sometimes referred to as a buffer layer or a buffer film.

The material containing carbon 105 preferably has flexibility so as to be easily changed in shape. An electrode or the like including the material containing carbon 105 is expected to have improved mechanical strength.

As described above, a graphene compound, graphene, or carbon fiber can be used as the material containing carbon 105; the aforementioned friction in moving can be inhibited when a graphene compound, graphene, or carbon fiber is only attached to the active material layer.

Only the attachment of the material containing carbon 105 to the active material layer is sufficient; in order to further reduce friction between adjacent negative electrode and positive electrode, the material containing carbon 105 is preferably formed into a layer or a film to be provided in the negative electrode 101. A layer of a material containing carbon and a film of a material containing carbon are sometimes referred to as a material layer containing carbon and a material film containing carbon, respectively. The material layer containing carbon or the material film containing carbon is preferably thinner so as to include a larger amount of active material per volume; the maximum thickness is less than or equal to 100 μm, preferably less than or equal to 10 μm. When the material layer containing carbon and the material film containing carbon are distinguished from each other, the material film containing carbon can be determined as a film with a maximum thickness less than or equal to 1 μm.

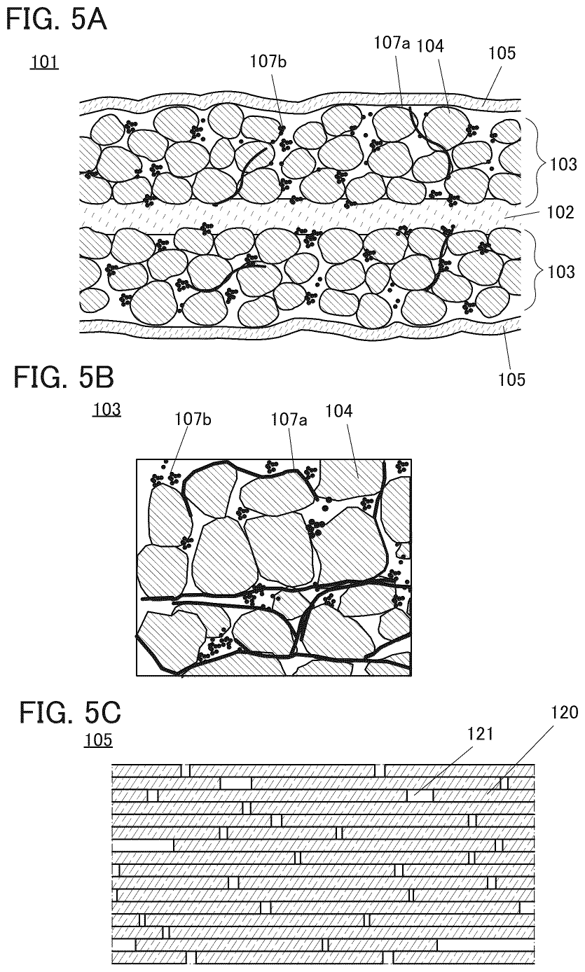

FIG. 5A illustrates details of the negative electrode 101, specifically the active material layer 103 and the like. The active material layer 103 includes an active material 104 (sometimes referred to as a negative electrode active material), a first conductive material 107a, and a second conductive material 107b. Although this embodiment shows an example of using the two conductive materials, one conductive material or three or more conductive materials may be used. The negative electrode 101 includes the current collector 102, and in some regions, the active material 104 is embedded in the current collector 102.

FIG. 5B is an enlarged view of the active material layer 103. The active material layer 103 includes the active material 104. Materials and the like for the active material 104, which will be described later, may include either primary particles or secondary particles. A plurality of active materials 104 are bonded to be in close contact with each other when the negative electrode 101 is pressed. The pressing or the like can increase the proportion of the active material per volume.

As illustrated in FIG. 5B, each of the first conductive material 107a and the second conductive material 107b is dispersed in the active material layer 103, and preferably dispersed in a uniform manner. Note that the second conductive material 107b includes fine particles and thus are less likely to be dispersed than the first conductive material 107a in some cases.

The first conductive material 107a, which is schematically shown by a thick line in FIG. 5B, is preferable because a film of the first conductive material 107a can be positioned so as to wrap or cover the plurality of active materials 104 or adhere to surfaces of the active material 104. Surfaces of a plurality of first conductive materials 107a can be in contact with each other. The first conductive materials 107a whose surfaces are in contact with each other are sometimes positioned so as to wrap or cover the plurality of active materials 104 or adhere to the surfaces of the active materials 104.

A graphene compound, graphene, or carbon fiber can be used as the first conductive material 107a. The graphene compound, which will be described later, is formed using a material exhibiting conductivity so as to be used as a conductive material. In addition, the graphene compound has a thickness of a single layer or multilayers of carbon molecules and thus has a very thin film shape, thereby being positioned so as to adhere to a surface of the active material 104. Graphene, which is thin because of having a thickness of multilayers of carbon molecules, has a rectangular shape in some cases. Carbon fiber may have a shape with fibers entangled with each other. Note that even graphene and carbon fiber can be positioned so as to touch the surface of the active material 104 by being pressed.

The graphene compound used as the first conductive material 107a is in a state where graphene compounds are bonded to each other; the graphene compound in this state is referred to as a graphene compound sheet or a graphene compound net in some cases. Graphene compounds are sometimes bonded to each other to form a mesh-like shape; the graphene compound in this state is referred to as a mesh-like graphene compound sheet or a mesh-like graphene compound net in some cases. Such a graphene compound sheet may be used as the first conductive material 107a.

When the graphene compound sheet is used as the first conductive material 107a, the graphene compound sheet can cover the active material 104 and serve as a binder. When the graphene compound sheet serves as a binder, the amount of a binder in the negative electrode 101 can be reduced or no binder is needed, which increases the proportion of the active material per volume in the negative electrode 101.

FIG. 5C is an enlarged view of the material containing carbon 105; in the illustrated example, a graphene compound sheet is used as the material containing carbon 105. The graphene compound sheet is as described in the first conductive material 107a and sometimes includes a plurality of planar graphene compounds 120 in the enlarged view as illustrated in FIG. 5C. Although the graphene compound 120 is shown, the graphene compound sheet includes graphene in some cases.

The length of one side (also referred to as a flake size) of the graphene compound is greater than or equal to 50 nm and less than or equal to 100 μm, preferably greater than or equal to 800 nm and less than or equal to 20 μm. Thus, a region 121 where ions can pass exists between adjacent graphene compounds. Such a graphene compound sheet has high ion conductivity to be preferably used as the material containing carbon 105. Through the region 121 or the like where ions can pass, an electrolyte, specifically, an electrolyte solution can enter the graphene compound sheet.

As illustrated in FIG. 5A, the graphene compound sheet can be provided along a surface of the active material layer 103 as the material containing carbon 105. Specifically, the graphene compound sheet can be provided continuously along parts of surfaces of the plurality of active materials 104 as the material containing carbon 105. Such a state may be described as follows: the material containing carbon 105 wraps the active material layer or the active material.

Although FIG. 5C illustrates an example of using the graphene compound sheet, a graphene sheet or a graphene net in which graphenes are bonded to each other may be used. The length of one side (also referred to as a flake size) of graphene is greater than or equal to 50 nm and less than or equal to 100 μm, preferably greater than or equal to 800 nm and less than or equal to 20 μm. Thus, a region where ions can pass exists between adjacent graphenes. Such a graphene sheet has high ion conductivity to be preferably used as the material containing carbon 105. The graphene sheet or the graphene net may be referred to as multilayer graphene on the basis of a cross-sectional view.

For the active material 104, a material capable of performing charging and discharging reactions by insertion and extraction of carrier ions is used. Lithium ions are used as the carrier ions. Besides lithium ions, sodium ions, potassium ions, calcium ions, strontium ions, barium ions, beryllium ions, magnesium ions, or the like may be used. Specific examples of the active material in the case of using lithium ions will be described later.

A material with a particulate shape can be used as the active material 104. The word “particulate” refers to the exterior shape having a given surface area, such as a spherical shape (powder shape), a plate shape, a horn shape, a columnar shape, a needle shape, or a flake shape. That is, a particulate active material is not necessarily spherical, and has any of the various external shapes described above. The plurality of active materials 104 included in the active material layer 103 may have different shapes.

A median diameter (D50) is usually used for the active materials 104 that have a particle size distribution; the median diameter (D50) of the active materials 104 is preferably greater than or equal to 10 nm and less than or equal to 30 μm, further preferably greater than or equal to 100 nm and less than or equal to 20 μm, still further preferably greater than or equal to 1 μm and less than or equal to 10 μm. A smaller median diameter (D50) is preferable because the negative electrode 101 is bent more easily as in FIG. 1B.

In the case where the active material 104 includes secondary particles, the median diameter (D50) of primary particles included in the secondary particles is preferably greater than or equal to 10 nm and less than or equal to 1 μm, further preferably greater than or equal to 100 nm and less than or equal to 500 m. A smaller median diameter (D50) is preferable because the negative electrode 101 is bent more easily as in FIG. 1B.

As described above, the material containing carbon 105 is provided along the shapes of the active materials 104 positioned on the surface of the active material layer 103 as illustrated in FIG. 5A so that the material containing carbon 105 wraps the active material layer 103. The material containing carbon 105 has high flexibility and thus can be provided along the shapes of the active materials 104.

Large expansion and contraction of the active material 104 with charging and discharging of the battery might cause collapse of the active material 104 from the current collector 102 due to the repetition of charging and discharging. The collapse of the active material 104 from the current collector 102 might be caused when the battery moves. In the flexible battery 100 of one embodiment of the present invention, the material containing carbon 105 is positioned to wrap the current collector 102 and the active material layer 103, which produces the force of holding the active material 104 and inhibits the collapse of the active material 104 from the current collector 102. When the material containing carbon 105 is in contact with the current collector 102 in a region, the force of holding the active material 104 is increased in some cases.

The material containing carbon 105 with a bag-like shape is prepared in order to efficiently wrap the current collector 102 and the active material layer 103. When the negative electrode 101 and the like are bent as illustrated in FIG. 1B, the current collector 102 and the active material layer 103 are unlikely to protrude from a side portion, a bottom portion, or the like of the bag-like material containing carbon 105, increasing safety or durability. The material containing carbon 105 not with a bag-like shape but with a cylindrical shape may be prepared. When the negative electrode 101 and the like are bent as illustrated in FIG. 1B, the current collector 102 and the active material layer 103 are unlikely to protrude also from a side portion or the like of the cylindrical material containing carbon 105, increasing safety or durability.

Although not illustrated in FIG. 5A and the like, the active material layer 103 preferably contains an electrolyte. A liquid electrolyte at room temperature (25° C.) is also referred to as an electrolyte solution. The material containing carbon 105 can be impregnated with an electrolyte solution. When the graphene compound sheet illustrated in FIG. 5C is used as the material containing carbon 105, the electrolyte solution can enter the graphene compound 120.

Although not illustrated in FIG. 5, the active material layer 103 may include a binder. Since the material containing carbon 105 can wrap the active material layer, a binder can be omitted.

### <Graphene Compound>

Here, a graphene compound will be described. First, graphene is described. Graphene has carbon atoms arranged in one atomic layer, and a 71 bond exists between the carbon atoms. In other words, graphene contains carbon, has a sheet-like (also referred to as a flat-plate-like) shape or the like, and has a two-dimensional structure formed of a six-membered ring composed of carbon atoms. The two-dimensional structure formed of the six-membered ring composed of carbon atoms may be referred to as a carbon sheet.

Graphene including two or more and one hundred or less layers is referred to as multilayer graphene in some cases. The length in the longitudinal direction or the length of the major axis in a plane in each of graphene and multilayer graphene is greater than or equal to 50 nm and less than or equal to 100 μm or greater than or equal to 800 nm and less than or equal to 50 μm.

Next, a graphene compound is described. A compound including graphene or multilayer graphene as a basic skeleton is referred to as a “graphene compound”. The graphene compound also includes graphene oxide described later, multilayer graphene oxide, reduced graphene oxide, reduced multilayer graphene oxide, graphene quantum dots, and the like.

A graphene compound is, for example, a compound where graphene or multilayer graphene is modified with an atom other than carbon or an atomic group with an atom other than carbon. A graphene compound may be a compound where graphene or multilayer graphene is modified with an atomic group composed mainly of carbon, such as an alkyl group or an alkylene group. An atomic group that modifies graphene or multilayer graphene is referred to as a substituent, a functional group, a characteristic group, or the like in some cases. Modification in this specification and the like refers to introduction of an atomic group with an atom other than carbon to graphene, multilayer graphene, a graphene compound, or graphene oxide (described later) by a substitution reaction, an addition reaction, or other reactions. Note that the surface and the rear surface of graphene may be modified with different atoms or atomic groups. In multilayer graphene, multiple layers may be modified with different atoms or atomic groups.

A graphene compound contains carbon, has a sheet-like shape or the like, and has a two-dimensional structure formed of a six-membered ring composed of carbon atoms, for example. The two-dimensional structure formed of the six-membered ring composed of carbon atoms may be referred to as a carbon sheet.

### <Graphene Oxide>

An example of the above-described graphene modified with an atom or an atomic group is graphene or multilayer graphene that is modified with oxygen or a functional group containing oxygen. Examples of the functional group containing oxygen include an epoxy group, a carbonyl group such as a carboxyl group, a hydroxyl group, and a lactol group. A graphene compound modified with oxygen or a functional group containing oxygen is referred to as graphene oxide in some cases. In this specification, graphene oxide includes multilayer graphene oxide. Graphene oxide can exhibit an insulating property.

### <Termination by Fluorine>

A material obtained by terminating an end portion of graphene by fluorine may be used as the graphene compound.

### <Formation Method of Graphene Oxide>

Next, a formation method example of graphene oxide is described. Graphene oxide can be obtained by oxidizing the aforementioned graphene or multilayer graphene. Alternatively, graphene oxide can be obtained by separating layers of graphite oxide. Graphite oxide can be formed by oxidizing graphite. The graphene oxide may be further modified with the above-mentioned atom or atomic group.

Examples of the formation method of graphene oxide include a variety of synthesis methods such as a Hummers method, a modified Hummers method, and oxidation of graphite.

For example, in the Hummers method and the modified Hummers method, graphite such as flake graphite is oxidized to give graphite oxide. The obtained graphite oxide is graphite which is oxidized in places and thus to which a functional group such as a carbonyl group, a carboxyl group, a hydroxyl group, or a lactol group is bonded. In the graphite oxide, the crystallinity of the graphite is lost and the distance between layers is increased. Therefore, the layers can be easily separated by ultrasonic treatment or the like to obtain graphene oxide.

Here, an example of a method for forming graphene oxide by the modified Hummers method is described. A sulfuric acid solution of potassium permanganate or the like is mixed into graphite powder to cause an oxidation reaction; thus, a mixed solution containing graphite oxide is formed. Because of the oxidation of carbon in graphite, graphite oxide has a functional group such as an epoxy group, a carbonyl group, a carboxy group, or a hydroxyl group. Accordingly, the interlayer distance in graphite oxide is longer than that in graphite. Then, ultrasonic vibration is applied to the mixed solution containing the graphite oxide, so that the graphite oxide with a long interlayer distance can be cleaved to separate graphene oxide and to form a dispersion liquid containing graphene oxide.

When graphene oxide is formed by the modified Hummers method described above, the obtained graphene oxide includes an element such as sulfur or nitrogen in some cases, for example.

The concentration of sulfur contained in a graphene compound of one embodiment of the present invention is preferably lower than or equal to 5%, and further preferably lower than or equal to 3%, for example.

The graphene compound of one embodiment of the present invention includes sulfur at a concentration of higher than or equal to 10 ppm and lower than or equal to 5%, higher than or equal to 100 ppm and lower than or equal to 3%, or higher than or equal to 0.1% and lower than or equal to 3% in some cases, for example.

Here, the concentration of sulfur contained in the graphene compound can be measured by, for example, elementary analysis such as XPS.

The graphene compound of one embodiment of the present invention includes, for example, nitrogen at a concentration of higher than or equal to 0.1% and lower than or equal to 3% in some cases.

### <Reduced Graphene Oxide>

A compound that can be obtained by reducing graphene oxide is referred to as “RGO (Reduced Graphene Oxide)” in some cases. Here, RGO is sometimes expressed as “rGO” as described in Non-Patent Document 1. In RGO, in some cases, all oxygen atoms contained in the graphene oxide are not extracted and part of them or an atomic group containing oxygen remains while being bonded to carbon. In some cases, RGO includes a functional group, e.g., an epoxy group, a carbonyl group such as a carboxyl group, or a hydroxyl group.

The reduced graphene oxide preferably includes a portion where the carbon concentration is higher than 80 atomic % and the oxygen concentration is higher than or equal to 2 atomic % and lower than or equal to 15 atomic %. Such carbon concentration and oxygen concentration can increase the conductivity of the reduced graphene oxide.

In addition, the intensity ratio G/D of a G band to a D band of the Raman spectrum of the reduced graphene oxide is preferably 1 or more. The reduced graphene oxide with such an intensity ratio can have high conductivity.

Note that graphene oxide can be reduced by heat treatment or with the use of a reducing agent, for example.

Reduced graphene oxide contains carbon and oxygen, has a sheet-like shape or the like, and has a two-dimensional structure formed of a six-membered ring composed of carbon atoms, for example.

### <Vacancy >

Reducing graphene oxide can form a vacancy in a graphene compound in some cases. The vacancy in the graphene compound corresponds to a region through which carrier ions, specifically lithium ions can pass. The vacancy facilitates insertion and extraction of carrier ions to increase the rate characteristics of the battery. The vacancy provided in part of a carbon sheet is referred to as a hole, a defect, or a gap in some cases. It is preferable that an ion of an alkali metal other than lithium, an anion and a cation used for an electrolyte, an anion and a cation contained in an electrolyte solution, and the like as well as carrier ions be capable of passing the vacancy.

The graphene compound may include a vacancy formed with a plurality of carbon atoms and one or more fluorine atoms. The plurality of carbon atoms are preferably bonded to each other in a ring shape and one or more of the plurality of carbon atoms bonded to each other in a ring shape are preferably terminated by fluorine. Fluorine has high electronegativity and is easily negatively charged. Approach of positively-charged lithium ions causes interaction to stabilize energy, whereby the barrier energy in passage of carrier ions, specifically lithium ions through a vacancy can be lowered. Thus, fluorine contained in a vacancy in the graphene compound allows carrier ions to easily pass through even a small vacancy; therefore, the graphene compound can have excellent conductivity.

### <Poly-Membered Ring>

A graphene compound may have a five-membered ring composed of carbon atoms or a poly-membered ring that is a seven or more-membered ring composed of carbon atoms, in addition to a six-membered ring composed of carbon atoms. In the neighborhood of a poly-membered ring which is a seven- or more-membered ring, a region through which ions can pass may be generated. The region through which ions can pass can be regarded as the vacancy described above. Examples of ions include carrier ions, specifically lithium ions. Other examples of the above ions include an ion of an alkali metal other than lithium, and an anion and a cation contained in an electrolyte solution.

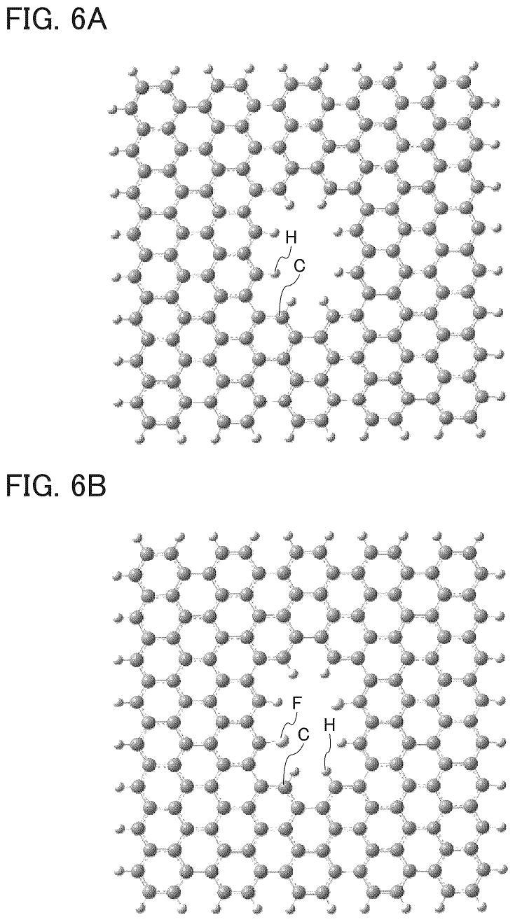

FIG. 6A and FIG. 6B each illustrate an example of a structure of a graphene compound having a vacancy.

The structure illustrated in FIG. 6A includes a 22-membered ring, and eight carbon atoms contained in the 22-membered ring are each terminated by hydrogen. In the structure, it can be said that two connected six-membered rings are removed from the graphene compound and carbon atoms bonded to the removed six-membered rings are terminated by hydrogen.

The structure illustrated in FIG. 6B includes a 22-membered ring, and six carbon atoms of eight carbon atoms of the carbon atoms contained in the 22-membered ring are terminated by hydrogen, and two carbon atoms thereof are terminated by fluorine. In the structure, it can be said that two connected six-membered rings are removed from the graphene compound and carbon atoms bonded to the removed six-membered rings are terminated by hydrogen or fluorine.

For example, in the case where the graphene compound has a vacancy, it is possible that a spectrum based on a feature caused by the vacancy is observed in Raman spectroscopic mapping measurement. Furthermore, it is possible that a bond, a functional group, and the like included in the vacancy are observed with time-of-flight secondary ion mass spectrometry (ToF-SIMS). It is also possible that the vicinity, surrounding, and the like of the vacancy are analyzed in TEM (transmission electron microscope) observation.

### <Sheet-Like Graphene Compound>

A graphene compound may have a sheet-like shape where a plurality of graphene compounds partly overlap with each other. A plurality of graphene compounds may be gathered to form a sheet-like shape. A graphene compound has a planar shape, thereby enabling surface contact. Such a graphene compound is sometimes referred to as a graphene compound sheet or a graphene compound net as described above. The graphene compound sheet has, for example, an area with a thickness greater than or equal to 0.33 nm and less than or equal to 100 μm, preferably greater than 0.34 nm and less than or equal to 10 μm.

In a graphene compound sheet, a region through which ions can pass may be generated between adjacent graphene compounds, for example. Accordingly, a graphene compound sheet may have high ionic conductivity. A graphene compound sheet may adsorb ions easily. As described above, examples of ions include carrier ions, specifically lithium ions. Other examples of the above ions include an ion of an alkali metal other than lithium, and an anion and a cation contained in an electrolyte solution.

It is considered that a graphene compound sheet in which a plurality of graphene compounds overlap with each other in a planar manner may be changed in shape in the case where external force is applied such that the graphene compounds slide on each other, and thus is less likely to be cracked.

Such a graphene compound sheet may be modified with an atom other than carbon, an atomic group containing an atom other than carbon, an atomic group composed mainly of carbon such as an alkyl group, or the like. A plurality of layers in the graphene compound sheet may be modified with different atoms or atomic groups.

### <Conductivity>

In some cases, a graphene compound has high conductivity even when it is thin. The contact area between graphene compounds or between a graphene compound and an active material can be increased by surface contact. Thus, a conductive path can be efficiently formed even with a small amount per volume.

### <Insulating Property>

A graphene compound can also be used as an insulator. For example, a graphene compound sheet can be used as a sheet-like insulator. Here, graphene oxide may have higher insulating property than a graphene compound that is not oxidized, for example. A graphene compound modified with an atomic group may have an improved insulating property, depending on the type of the modifying atomic group.

### <Formation Method of Graphene Compound>

A graphene compound can be formed by a spray-drying method, a coating method, or the like. In the description in this embodiment, as an example, a graphene compound sheet is formed by a spray-drying method using a graphene oxide dispersion liquid as a raw material. Note that graphene oxide included in the graphene oxide dispersion liquid may be multilayer graphene oxide, and the graphene oxide dispersion liquid includes graphene oxide or graphene oxide and multilayer graphene oxide in some cases.

A solvent used for the graphene oxide dispersion liquid is preferably a polar solvent. For example, one of water, methanol, ethanol, acetone, tetrahydrofuran (THF), dimethylformamide (DMF), 1-methyl-2-pyrrolidone (NMP), dimethyl sulfoxide (DMSO), ethylene glycol, diethylene glycol, and glycerin, or a mixed solution of two or more of the above can be used as the polar solvent.

A plurality of graphene oxide films are formed over a substrate or a plate by a spray-drying method, so that a graphene compound containing graphene oxide can be obtained. A graphene compound sheet can also be formed with a plurality of graphene compounds that overlap with each other in the deposition. The spray-drying method is suitable for formation of a graphene compound or a graphene compound sheet of one embodiment of the present invention because the thickness of the graphene compound or the graphene compound sheet can be controlled by adjustment of the deposition time, the concentration of a dispersion liquid, or the like.

The graphene compound or the graphene compound sheet can be separated from the substrate or the plate. The substrate or the plate can be regarded as the active material layer in FIG. 1 to FIG. 5 and the like; the graphene compound or the graphene compound sheet can be deposited over the active material layer. In that case, the graphene compound or the graphene compound sheet is not necessarily separated.

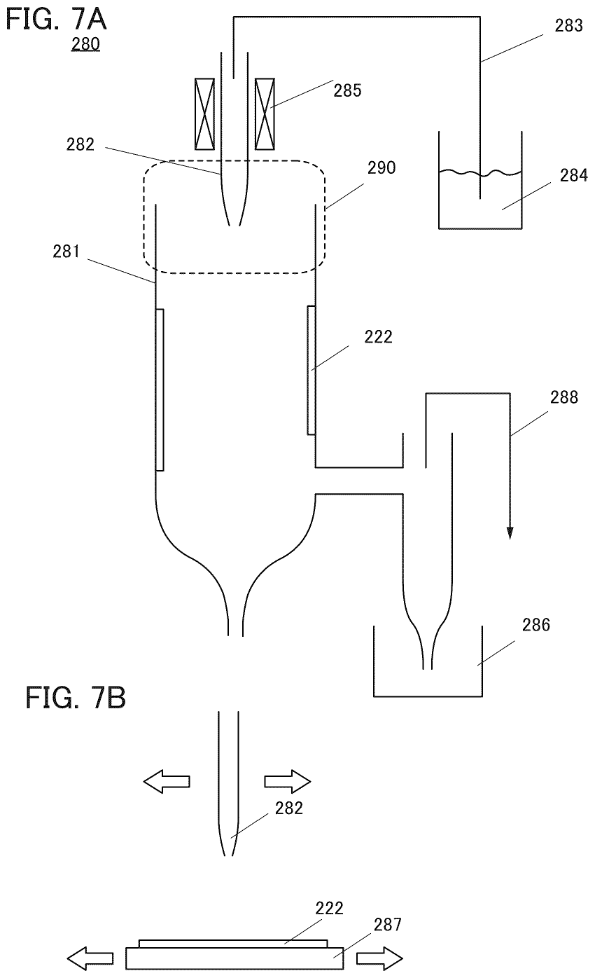

FIG. 7A shows a schematic diagram of a spray-drying apparatus 280. The spray-drying apparatus 280 includes a chamber 281 and a nozzle 282. A dispersion liquid 284 is pumped up with a pump (not illustrated), and supplied to the nozzle 282 through a tube 283. A mist of dispersion liquid 284 is supplied to the chamber 281, and the dispersion liquid 284 is dried in the chamber 281.

The spray-drying apparatus 280 may include a heater 285 to heat the nozzle 282. The heater 285 also heats a region of the chamber 281 that is close to the nozzle 282, for example, a region 290 surrounded by the dashed line in FIG. 7A in some cases.

In the case where a graphene oxide dispersion liquid is used as the dispersion liquid 284, graphene oxide supplied from the graphene oxide dispersion liquid becomes a graphene compound or a graphene compound sheet 222, which is deposited on a wall surface of the chamber 281. Part of the graphene oxide supplied from the graphene oxide dispersion liquid is dried in the chamber 281 to be in a powder state, thereby being collected from the chamber 281 in a collection container 286. A nozzle (not illustrated) may be connected to the collection container 286, and graphene oxide may be collected through the nozzle. The collected graphene oxide can be reused as a graphene oxide dispersion liquid.

The air in the chamber 281 may be adjusted; for example, the inside of the chamber 281 may be suctioned by an aspirator or the like through a path indicated by an arrow 288 in FIG. 7A. Furthermore, a nozzle (not illustrated) may be connected to the collection container 286, and graphene oxide may be collected through the nozzle.

A substrate or a plate may be provided in the chamber 281, and a graphene compound or a graphene compound sheet may be deposited thereover. The substrate or the plate may have a flat-plate shape or a curved shape. The substrate or the plate can be regarded as the active material layer in FIG. 1 to FIG. 5 and the like; the graphene compound or the graphene compound sheet can be deposited over the active material layer with an uneven surface.

The substrate or the plate may be set parallel to the nozzle 282 or at a certain angle. A spray may be used instead of the nozzle 282. For example, the substrate or the plate may be set perpendicular to the nozzle 282. FIG. 7B illustrates an example in which a substrate 287 is set to be perpendicular to the nozzle 282 and the graphene compound or the graphene compound sheet is deposited over the substrate. For example, deposition is performed while the nozzle 282 is moved horizontally as indicated by arrows, so that the graphene compound or the graphene compound sheet can have improved thickness uniformity in a plane. The thickness uniformity in a plane of the graphene compound or the graphene compound sheet may be improved by moving the substrate 287 horizontally as indicated by arrows. Furthermore, both the nozzle 282 and the substrate 287 may be moved horizontally as indicated by the arrows in order to improve the thickness uniformity in a plane of the graphene compound or the graphene compound sheet.

An example of the interlayer distance in the graphene compound or the graphene compound sheet is described. The interlayer distance in the graphene compound or the graphene compound sheet is, for example, longer than or equal to 0.335 nm and shorter than or equal to 0.7 nm, longer than 0.34 nm and shorter than or equal to 0.6 nm, longer than 0.34 nm and shorter than or equal to 0.5 nm, or longer than 0.34 nm and shorter than 0.44 nm. These interlayer distances allow carrier ions to move between layers.

Examples of a method for calculating the interlayer distance include observation with a TEM and evaluation using X-ray diffraction (XRD). In observation with a TEM, a small region, e.g., a several-nanometer to several-micrometer square region, is observed. By contrast, in evaluation using XRD, average data on a larger region can be evaluated in some cases.

The graphene compound or the graphene compound sheet formed in this manner can exhibit an insulating property.

In the case where the graphene compound or the graphene compound sheet exhibiting conductivity is formed, reduction treatment is performed. The reduction of the graphene compound or the graphene compound sheet can reduce graphene oxide to improve the conductivity of the graphene compound or the graphene compound sheet.

As described above, examples of a reduction treatment method include reduction by heat treatment and reduction using a reducing agent (also referred to as chemical reduction). The reduction temperature in the chemical reduction is, for example, higher than or equal to room temperature and lower than or equal to 100° C., preferably higher than or equal to 40° C. and lower than or equal to 70° C. The treatment time in the chemical reduction is longer than or equal to 3 minutes and shorter than or equal to 10 hours, preferably longer than or equal to 30 minutes and shorter than or equal to 3 hours.

Examples of the reducing agent include ascorbic acid, hydrazine, dimethyl hydrazine, hydroquinone, sodium boron hydride (NaBH₄), lithium aluminum hydride (LiAlH₄), N,N-diethylhydroxylamine, and a derivative thereof. For example, ascorbic acid and hydroquinone are preferable to hydrazine and sodium boron hydride in that they are safe due to low reducing ability and utilized industrially with ease.

In the above description, a polar solvent can be used as a solvent in the graphene oxide dispersion liquid; there is no particular limitation on the polar solvent as long as the reducing agent can be dissolved.

A reducing agent may be included as a graphene oxide dispersion liquid. That is, instead of the solvent, a reducing liquid containing a solvent and a reducing agent may be included in the graphene oxide dispersion liquid. As the reducing liquid, a mixed solution of ethanol and ascorbic acid, or a mixed solution of water, ascorbic acid, and lithium hydroxide can be used.

In the graphene oxide dispersion liquid, protons might be added to graphene oxide by ascorbic acid. Then, H₂O is released by subsequent heat treatment or the like to reduce the graphene oxide.

After the reduction treatment, cleaning may be performed. The cleaning is performed using, for example, a solution given as the solvent. Note that the cleaning may be performed using a solution containing the same solvent as the solvent contained in the reducing liquid, or a solution containing a solvent different from the solvent contained in the reducing liquid. A drying step may be performed after the cleaning.

Next, thermal reduction is described. The thermal reduction step is performed, for example, at a temperature higher than or equal to 50° C. and lower than 500° C., preferably higher than or equal to 120° C. and lower than or equal to 400° C. for longer than or equal to 1 hour and shorter than or equal to 48 hours, preferably longer than or equal to 2 hours and shorter than or equal to 20 hours. The thermal reduction may be performed under a reduced pressure (in vacuum), in a reduction atmosphere, or under an atmospheric pressure. As a gas for reduction, air or an inert gas such as nitrogen may be used.

The graphene compound or the graphene compound sheet formed in this manner can exhibit conductivity.

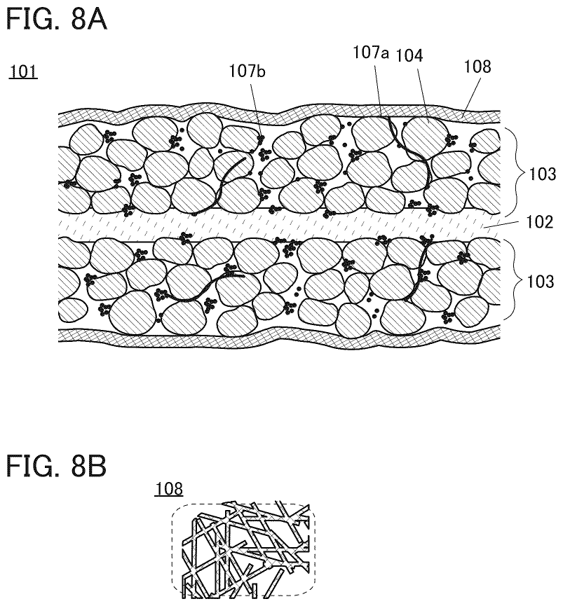

FIG. 8A illustrates a structure of the negative electrode 101, which includes carbon fiber 108 as the material containing carbon 105 illustrated in FIG. 5A and the like. FIG. 8B is an enlarged view of the carbon fiber 108. Since the other structures are similar to those in FIG. 5A and the like, the description thereof is omitted.

The carbon fiber 108 is flexible and can be easily changed in shape, which can increase the mechanical strength of the negative electrode or the like.

A fibrous material having a specific surface area greater than or equal to 5 m²/g and less than 60 m²/g is used as the carbon fiber 108. For example, carbon fiber such as mesophase pitch-based carbon fiber or isotropic pitch-based carbon fiber can be used as the carbon fiber 108. Carbon nanofiber, carbon nanotube, or the like can also be used as the carbon fiber 108. Carbon nanofiber or carbon nanotube can be formed by, for example, a vapor deposition method.

The carbon fiber 108 is provided along the shapes of the active materials 104 positioned on the surface of the active material layer 103 as illustrated in FIG. 8A in the state where the carbon fiber 108 wraps the active material layer 103. The carbon fiber 108 has high flexibility and thus can be provided along the shapes of the active materials 104.

Large expansion and contraction of the active material 104 with charging and discharging of the battery might cause collapse of the active material 104 from the current collector 102 due to the repetition of charging and discharging. The collapse of the active material 104 from the current collector 102 might be caused when the battery moves. In the flexible battery 100 of one embodiment of the present invention, the carbon fiber 108 is positioned to wrap the current collector 102 and the active material layer 103, which produces the force of holding the active material 104 and inhibits the collapse of the active material 104 from the current collector 102. When the carbon fiber 108 is in contact with the current collector 102 in a region, the force of holding the active material 104 is increased in some cases.

Although not illustrated in FIG. 8A and the like, the active material layer 103 contains a binder and an electrolyte. A liquid electrolyte is also referred to as an electrolyte solution. The carbon fiber 108 can be impregnated with an electrolyte solution and is preferably dispersed so that carrier ions can pass through the carbon fiber 108.

The material containing carbon 105 illustrated in FIG. 5(A) and the like and the carbon fiber 108 illustrated in FIG. 8 and the like may have conductivity. Graphene or the like can be selected as the material containing carbon 105 having conductivity.

The material containing carbon 105 illustrated in FIG. 5 and the like may have an insulating property. Graphene oxide, reduced graphene oxide, or the like can be selected as the material containing carbon 105 having conductivity. The material containing carbon 105 preferably has an insulating property high enough to prevent a short circuit between the positive electrode and the negative electrode, in which case the separator can be omitted. The material containing carbon 105 having an insulating property can be selected from the materials described later, and is preferably a material having a high proportion of oxygen.

The material containing carbon 105 illustrated in FIG. 5 and the like and the carbon fiber 108 illustrated in FIG. 8 and the like may be mixed in a polymer material. The insulating property can be exhibited by changing the proportion of the polymer material. As the polymer material, polypropylene (PP), polyethylene (PE), polybutene, nylon, polyester, polysulfone, polyacrylonitrile, polyvinylidene fluoride, tetrafluoroethylene, or the like can be used. The polymer material is preferable because the material containing carbon 105 and the carbon fiber 108 can have an insulating property without loss of flexibility and the like.

### <Positive Electrode>

Next, FIG. 9A and FIG. 9B show details of the positive electrode 131. FIG. 9A is a cross-sectional view of the positive electrode 131, and FIG. 9B is a top view of the positive electrode 131. The cross-sectional view in FIG. 9A corresponds to a cross section of a position denoted by a dotted line in FIG. 9B.

The positive electrode 131 includes the current collector 132 and the active material layer 133. As illustrated in FIG. 9A, the active material layer 133 is preferably formed on two surfaces (one surface and the other surface) of the current collector 132. As described above, a structure in which the active material layer 133 is formed on two surfaces is referred to as a double-side forming structure or a double-side coating structure. Although not illustrated in FIG. 9A, the active material layer 133 may be formed on either one surface or the other surface of the current collector 132. As described above, a structure in which the active material layer 133 is formed on one surface is referred to as a single-side forming structure or a single-side coating structure.

As illustrated in FIG. TA to FIG. 3B, FIG. 9A, and FIG. 9B, the current collector 132 and the active material layer 133 are wrapped by the material containing carbon 105 in the positive electrode 131. In other words, the material containing carbon 105 wraps the current collector 132 and the active material layer 133. In the flexible battery 100 of one embodiment of the present invention with such a structure including the material containing carbon 105, the material containing carbon 105 serves as what is called a cushioning material that reduces friction when the state in FIG. TA and the state in FIG. 1B are repeated; thus, the flexible battery 100 can easily move.

The material containing carbon 105 is flexible and can be easily changed in shape, which can increase the mechanical strength of the positive electrode or the like.

As in the structure illustrated in FIG. 5, the positive electrode 131 also includes an active material, a conductive material, a binder, an electrolyte solution, and the like. As in the structure illustrated in FIG. 8, the positive electrode 131 may include the carbon fiber 108 instead of the material containing carbon 105.

The carbon fiber 108 is flexible and can be easily changed in shape, which can increase the mechanical strength of the positive electrode or the like.

### Structure Example 2

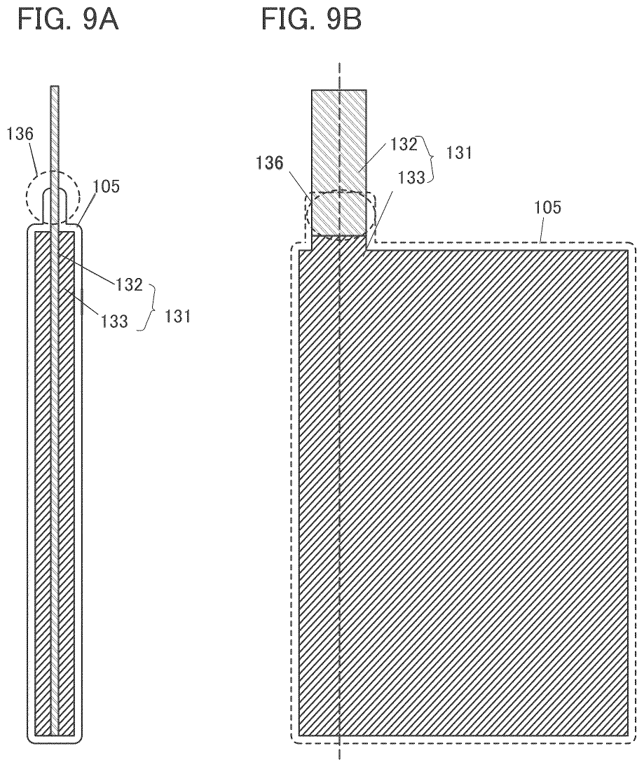

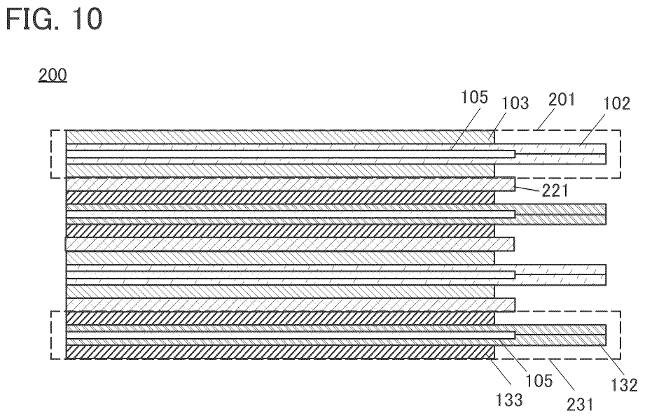

A flexible battery 200 is described as Structure example 2: unlike in Structure example 1 described above, the active material layer has a single-side forming structure or a single-side coating structure, and a material containing carbon is provided between current collectors overlapping with each other. A cross-sectional view illustrated in FIG. 10 illustrates the flexible battery 200 in a flat state. The flexible battery 200 of one embodiment of the present invention can be repeatedly changed between the flat state illustrated in FIG. 10 and a curved state.

A negative electrode 201 includes the current collector 102 and the active material layer 103, like the negative electrode 101 of Structure example 1 described above. The active material layer 103 has a single-side forming structure or a single-side coating structure, and thus is formed on a surface of the current collector 102. Another pair of the current collector 102 and the active material layer 103 is prepared, and the material containing carbon 105 is provided between the two current collectors 102 overlapping with each other. Such a negative electrode 201 is prepared.

Like the positive electrode 131 in Structure example 1 described above, a positive electrode 231 includes the current collector 132 and the active material layer 133. The active material layer 133 has a single-side forming structure or a single-side coating structure, and thus is formed on a surface of the current collector 132. Another pair of the current collector 132 and the active material layer 133 is prepared, and the material containing carbon 105 is provided between the two current collectors 132 overlapping with each other. Such a positive electrode 231 is prepared.

A separator 221 is positioned between the negative electrode 201 and the positive electrode 231.

In the case of Structure example 2, the material containing carbon 105 is positioned between two current collectors. In the flexible battery 200 of one embodiment of the present invention with such a structure including the material containing carbon 105, the material containing carbon 105 serves as what is called a cushioning material that reduces friction when the state in FIG. 10 and the curved state are repeated; thus, the flexible battery 200 can easily move. That is, the material containing carbon 105 is sometimes referred to as a buffer layer. The material containing carbon 105 positioned between two current collectors may exhibit an insulating property but preferably exhibits conductivity.

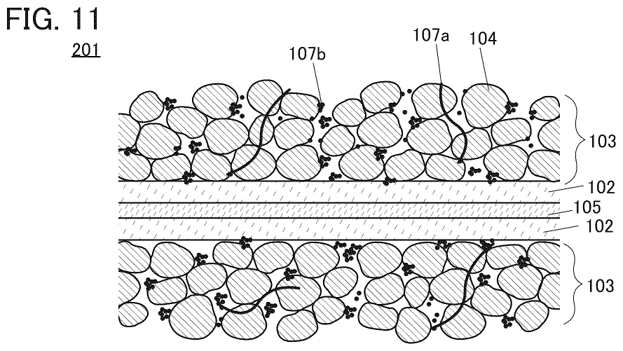

FIG. 11 illustrates details of the negative electrode 201, specifically the active material layer 103 and the like. Like the active material layer 103 and the like illustrated in FIG. 5, the active material layer 103 in FIG. 11 includes the material containing carbon 105 between the two current collectors 102 in the negative electrode 201. Although not illustrated in FIG. 11, the active material layer 103 includes a binder and an electrolyte as in FIG. 5, and the electrolyte may be an electrolyte solution. The material containing carbon 105 positioned between the two current collectors 102 is not necessarily impregnated with an electrolyte solution and does not necessarily include a vacancy through which carrier ions can pass.

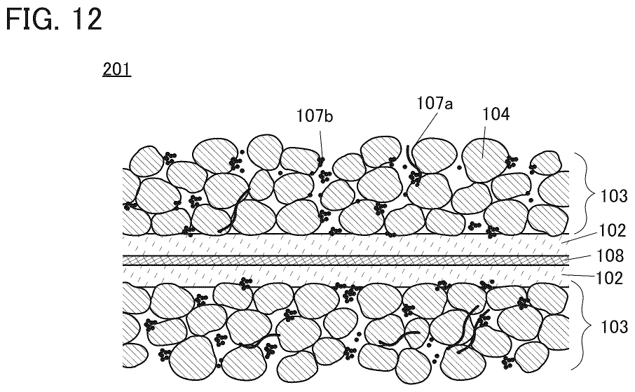

FIG. 12 illustrates a structure of the negative electrode 101, which includes the carbon fiber 108 instead of the material containing carbon 105 illustrated in FIG. 11 and the like. Since the other structures are similar to those in FIG. 11, the description thereof is omitted. In the flexible battery 200 of one embodiment of the present invention with such a structure including the carbon fiber 108, the carbon fiber 108 serves as what is called a cushioning material that reduces friction when the state in FIG. 12 and the curved state are repeated; thus, the flexible battery 200 can easily move. That is, the carbon fiber 108 is sometimes referred to as a buffer layer. The carbon fiber 108 positioned between two current collectors may exhibit an insulating property but preferably exhibits conductivity.

As described in this embodiment, the flexible battery including a graphene compound, carbon fiber, or the like is preferable because of having high safety or durability.

This embodiment can be implemented in appropriate combination with the other embodiments.

### Embodiment 2

In this embodiment, a flexible battery 300 of one embodiment of the present invention will be described.

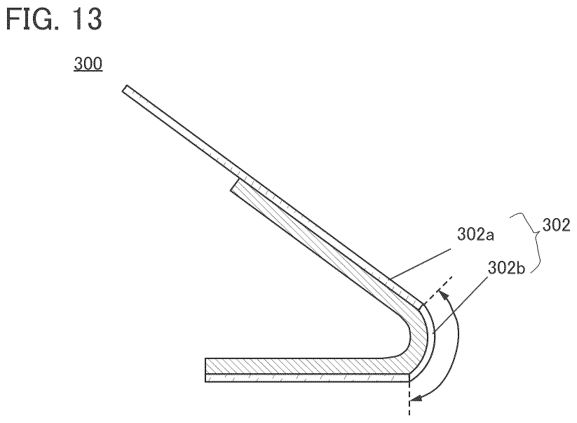

The flexible battery 300 includes a new current collector that can be used for the flexible batteries described in Structure example 1 and Structure example 2 above. As illustrated in FIG. 13, when the flexible battery 300 is bent, a current collector 302 includes a flat region and a curved region. In the current collector 302, different materials are preferably used for a first current collector 302a positioned in the flat region and a second current collector 302b positioned in the curved region. For example, the second current collector 302b is preferably formed using a material having higher flexibility than that for the first current collector 302a, and any of the graphene compounds described in the above embodiment is used.

### Structure Example 3

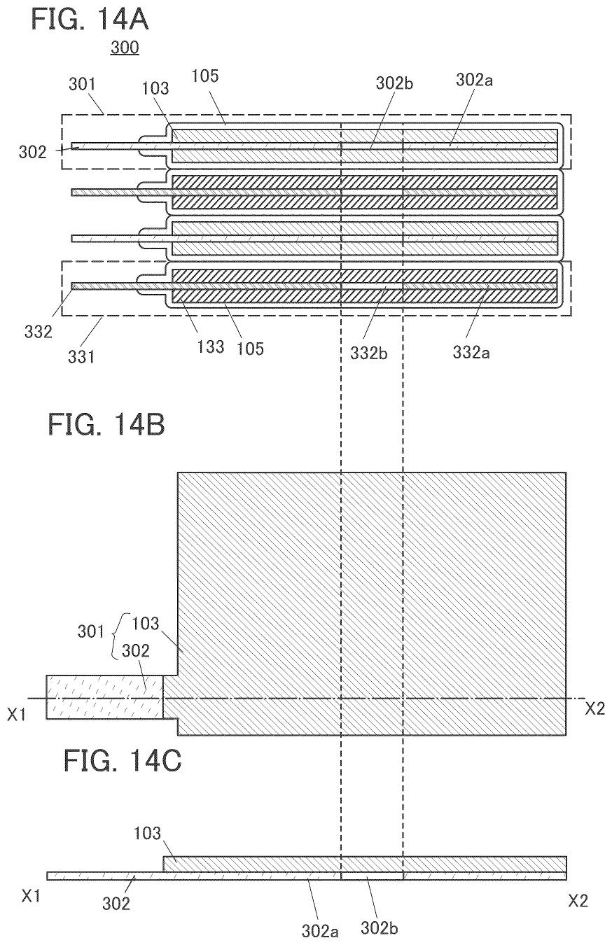

A cross-sectional view illustrated in FIG. 14A illustrates the flexible battery 300 in a flat state. The flexible battery 300 has a structure in which a negative electrode 301 and a positive electrode 331 are stacked as in the above embodiment.

The negative electrode 301 includes the current collector 302, the current collector 302 includes the first current collector 302a and the second current collector 302b, and the second current collector 302b is placed to overlap with a curved region. For example, as the second current collector 302b, the graphene compound described in the above embodiment may be used. The other structures of the negative electrode 301 are similar to those in the above embodiment.

The positive electrode 331 includes a current collector 332, the current collector 332 includes a first current collector 322a and a second current collector 322b, and the second current collector 322b is placed to overlap with a curved region. For example, as the second current collector 322b, the graphene compound described in the above embodiment may be used. The other structures of the positive electrode 331 are similar to those in the above embodiment.

FIG. 14B is atop view of the negative electrode 301. As described above, the negative electrode 301 includes the current collector 302 and the active material layer 103, and the active material layer 103 is positioned above the current collector 302. The second current collector 302b overlaps with a curved region of the flexible battery 300; in FIG. 14B, the position of the second current collector 302b is denoted by dashed lines. The second current collector 302b overlapping with the curved region is selectively formed along the direction parallel to a short side of the current collector 302.

FIG. 14C is a cross-sectional view of the negative electrode 301. The cross-sectional view in FIG. 14C corresponds to a cross section along the dashed-dotted line X1-X2 in FIG. 14B. As described above, the negative electrode 301 includes the current collector 302 and the active material layer 103, and the active material layer 103 is positioned above the current collector 302. The current collector 302 includes the second current collector 302b and the first current collector 302a, which overlap with the curved region and a flat region of the flexible battery 300, respectively. Different current collector materials are preferably used for the first current collector 302a and the second current collector 302b.

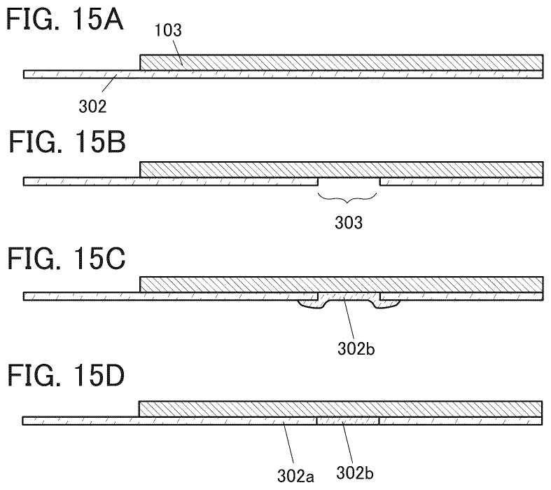

Next, a manufacturing process of the negative electrode 301 corresponding to the cross-sectional view in FIG. 14C is described with reference to FIG. 15A to FIG. 15D. As illustrated in FIG. 15A, the active material layer 103 is formed over the current collector 302. The active material layer 103 is obtained by application of slurry containing an active material or the like onto the current collector 302 and drying. After that, as illustrated in FIG. 15B, an opening portion 303 is formed in the current collector 302 so as to correspond to the curved region. Then, as illustrated in FIG. 15C, a new current collector to be the second current collector 302b is formed in the opening portion 303. A surface of the second current collector 302b is preferably level with a surface of the current collector 302; as illustrated in FIG. 15D, an unnecessary region of the new current collector is removed to obtain the current collector 302 including the first current collector 302a and the second current collector 302b.

### Structure Example 4

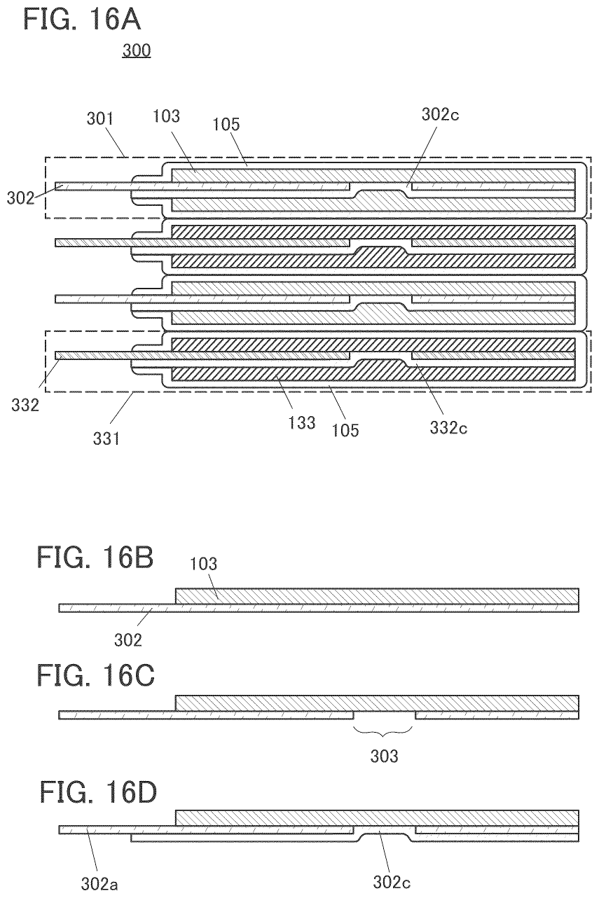

A cross-sectional view illustrated in FIG. 16A illustrates the flexible battery 300 in a flat state. The flexible battery 300 has a structure in which the negative electrode 301 and the positive electrode 331 are stacked as in the above embodiment.

The negative electrode 301 includes the current collector 302, and the current collector 302 includes a third current collector 302c overlapping with a curved region. Unlike in Structure example 3 described above, the third current collector 302c is formed in an opening portion and around the opening portion in this structure. The third current collector 302c is formed using a material having high flexibility, and thus can be formed around the opening portion. The third current collector 302c also includes a region in contact with the material containing carbon 105, which is preferable because the material containing carbon 105 has high adhesion to the third current collector 302c.

The positive electrode 331 includes the current collector 332, and the current collector 332 includes a third current collector 332c overlapping with a curved region. Unlike in Structure example 3 described above, the third current collector 332c is formed in an opening portion and around the opening portion in this structure. The third current collector 332c is formed using a material having high flexibility, and thus can be formed around the opening portion. The third current collector 332c also includes a region in contact with the material containing carbon 105, which is preferable because the material containing carbon 105 has high adhesion to the third current collector 332c.

Next, a manufacturing process of the negative electrode 301 is illustrated in FIG. 16B to FIG. 16D. As illustrated in FIG. 16B, the active material layer 103 is formed over the current collector 302. The active material layer 103 is obtained by application of slurry containing an active material or the like onto the current collector 302 and drying. After that, as illustrated in FIG. 16C, the opening portion 303 is formed in the current collector 302 so as to correspond to the curved region. Then, as illustrated in FIG. 16D, a new current collector to be the third current collector 302c is formed so as to overlap with at least the opening portion 303. Part of the current collector 302 remains and is referred to as the first current collector 302a.

This process does not include the step of removing the current collector illustrated in FIG. 15D. The number of steps can be reduced in this process.

### Structure Example 5

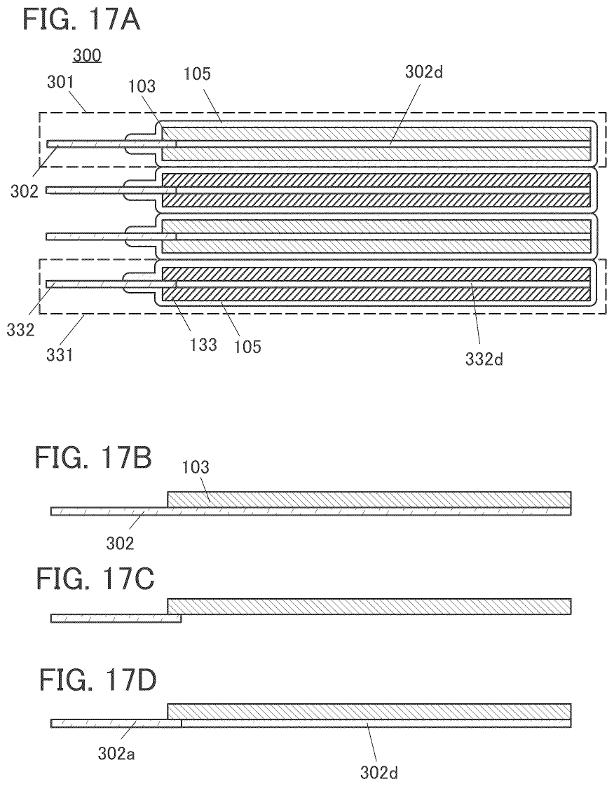

A cross-sectional view illustrated in FIG. 17A illustrates the flexible battery 300 in a flat state. The flexible battery 300 has a structure in which the negative electrode 301 and the positive electrode 331 are stacked as in the above embodiment.

The negative electrode 301 includes the current collector 302, and a fourth current collector 302d is formed in the entire region including a curved region. Unlike in Structure example 3 and Structure example 4 described above, the fourth current collector 302d is provided as the current collector 302 in Structure example 5.

The positive electrode 331 includes the current collector 332, and a fourth current collector 332d is formed in the entire region including a curved region as in the negative electrode. Unlike in Structure example 3 and Structure example 4 described above, the fourth current collector 332d is provided as a current collector 322 in Structure example 5.

Next, a manufacturing process of the negative electrode 301 is illustrated in FIG. 17B to FIG. 17D. As illustrated in FIG. 17B, the active material layer 103 is formed over the current collector 302. The active material layer 103 is obtained by application of slurry containing an active material or the like onto the current collector 302 and drying. After that, as illustrated in FIG. 17C, the current collector 302 is removed so that the active material layer 103 is exposed. Then, as illustrated in FIG. 17D, a new current collector to be the fourth current collector 302d is formed so as to cover the exposed active material layer 103. Part of the current collector 302 remains and is referred to as the first current collector 302a.

### Structure Example 6

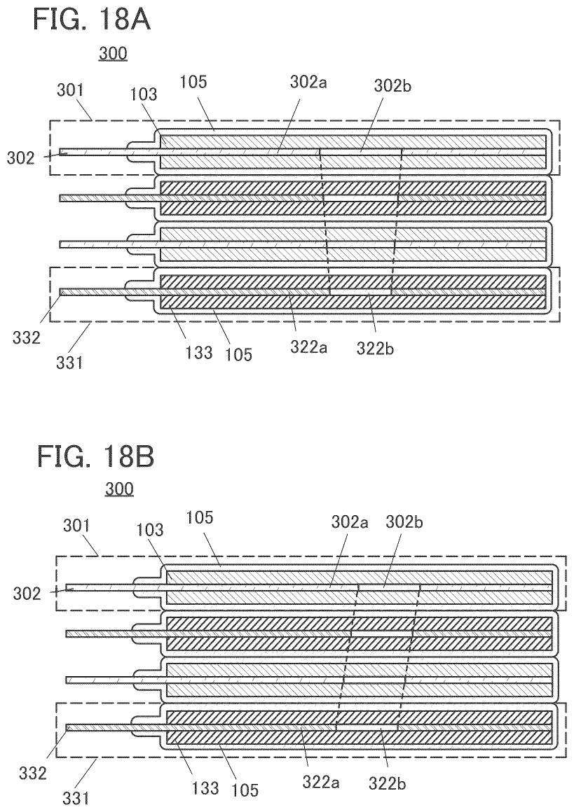

A cross-sectional view illustrated in FIG. 18A illustrates the flexible battery 300 in a flat state. The flexible battery 300 has a structure in which the negative electrode 301 and the positive electrode 331 are stacked as in the above embodiment. The second current collector 302b is formed to be positioned in a curved region as in Structure example 3, and the area of the second current collector 302b positioned outside when being curved is larger than the area of the second current collector 302b positioned inside. That is, the area of the opening portion 303 positioned outside is larger than that positioned inside. This area may be denoted by the width in a cross-sectional view.

The above description is based on Structure example 3; also in Structure example 4, the area of the opening portion 303 positioned outside is larger than that positioned inside. This area may be denoted by the width in a cross-sectional view.

### Structure Example 7

A cross-sectional view illustrated in FIG. 18B illustrates the flexible battery 300 in a flat state. The flexible battery 300 has a structure in which the negative electrode 301 and the positive electrode 331 are stacked as in the above embodiment. The second current collector 302b is formed to be positioned in a curved region as in Structure example 3, and the position of the opening portion 303 positioned outside when being curved is shifted toward the opening portion 303 positioned inside.

The above description is based on Structure example 3; also in Structure example 4, the position of the opening portion 303 positioned outside can be shifted toward the opening portion 303 positioned inside.

As shown in this embodiment, anew current collector is formed using different materials for a current collector positioned in a curved region and another current collector. The flexible battery 300 having such a structure is preferable because of its high movable property.

This embodiment can be implemented in appropriate combination with the other embodiments.

### Embodiment 3

In this embodiment, a structure example of an exterior body of a flexible battery, and the like will be described. For the exterior body, a metal material such as aluminum and/or a resin material can be used. These materials may be stacked; for example, the exterior body may have a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film. The insulating synthetic resin film is used as the outer surface of the exterior body.

A surface of the exterior body has a wave shape. The wave shape includes a shape with an uneven surface whose projections are continuous in one direction. The continuous projections preferably have a periodic distance, and further preferably have the same height. When the flexible battery is bent, the exterior body having the above-described wave shape can be changed in shape so that the period and height of the projections change, which relieves bending stress and prevents damage of the exterior body.

When the flexible battery is bent, one side of the exterior body to which a tab or the like is connected is preferably fixed while an end of an electrode with a stacked-layer structure is shifted on another side, specifically a side facing the one side. That is, the electrode with a stacked-layer structure is bent with the position of the tab or the like as a fixed point and a pivot, and the exterior body having the wave shape can be changed in shape so as to follow the bending.

Furthermore, on the side of the exterior body where the end of the electrode with a stacked-layer structure is shifted, a space may be included between the end of the electrode and an inner wall of the exterior body, specifically, inside the exterior body. This space allows the battery cell with a stacked-layer structure to be shifted when the flexible battery is bent, whereby the end of the electrode with a stacked-layer structure can be prevented from touching the inner wall of the exterior body. Even in the case where the electrode with a stacked-layer structure has a large thickness, the space inhibits the end of the electrode with a stacked-layer structure from touching the inner wall of the exterior body, thereby preventing damage of the exterior body. For example, the flexible battery can be bent and stretched safely even when the electrode with a stacked-layer structure has a thickness greater than 400 μm, e.g., greater than or equal to 500 μm or greater than or equal to 1 mm. Damage of the exterior body can also be prevented by the space even when the electrode with a stacked-layer structure has an extremely small thickness of 1 μm to 400 μm.

In the flexible battery of one embodiment of the present invention, there is no limitation on the thickness of the electrode with a stacked-layer structure; the thickness may depend on the capacitance necessary for an electronic device including the flexible battery or the shape of a region where the flexible battery is mounted.

In the flexible battery of one embodiment of the present invention, the thickness of the negative electrode or the positive electrode is, for example, less than or equal to 10 mm, preferably less than or equal to 5 mm, further preferably less than or equal to 4 mm, still further preferably less than or equal to 3 mm.

In order to make the space inside the exterior body larger, the projection position is preferably shifted between the surface of the exterior body positioned above the electrode with a stacked-layer structure and the rear surface of the exterior body positioned below the electrode with a stacked-layer structure. Specifically, the projection position of the surface of the exterior body positioned above the electrode with a stacked-layer structure is determined so as not to overlap with, i.e., so as to be shifted from, the projection position of the rear surface of the exterior body positioned below the electrode with a stacked-layer structure. Note that the projection of the rear surface of the exterior body refers to a region that protrudes to the side opposite to the electrode with a stacked-layer structure. Since the projections have periodicity, the aforementioned shift can be referred to as a 180-degree phase shift. The exterior body having such a wave shape is preferable because the space can be formed at a position with the maximum distance between the exterior body and the electrode with a stacked-layer structure.

In one embodiment of the present invention, the electrode with a stacked-layer structure can be held by an exterior body folded in half. The projection phase is preferably shifted as described above when the exterior body is folded in half. The projection phase is preferably shifted by 180 degrees. It is preferable to apply pressure and heat so that the fold of the exterior body become flat.

More specific structure examples and a fabrication method example will be described below with reference to drawings.

### Structure Example 8

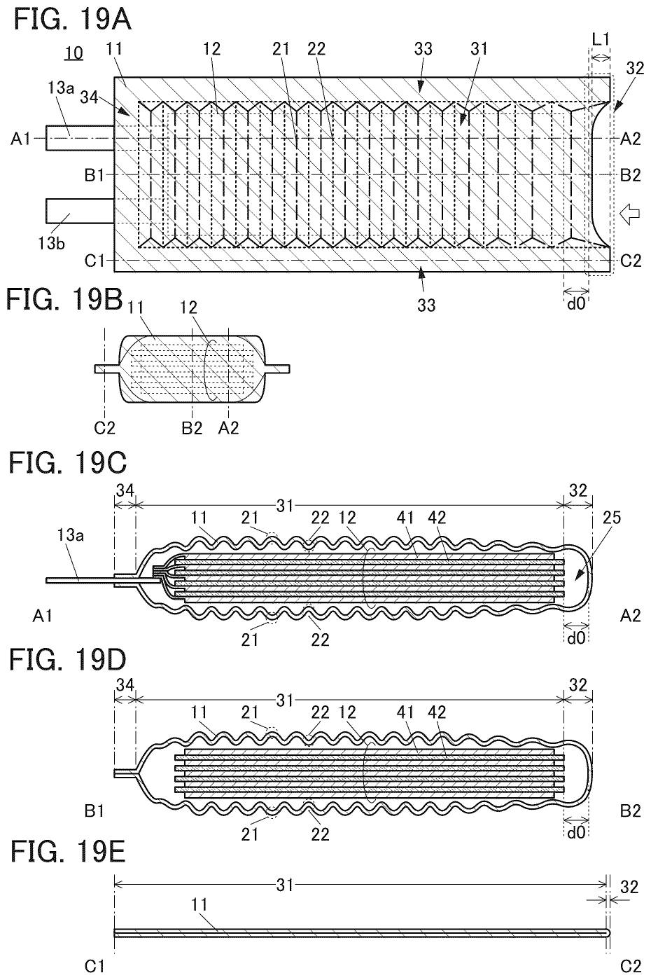

FIG. 19A is a top view of the flexible battery 10 described below as an example. FIG. 19B is a view of the flexible battery 10 seen from the direction shown by a hollow arrow in FIG. 19A. FIG. 19C, FIG. 19D, and FIG. 19E are schematic cross-sectional views taken along A1-A2, B1-B2, and C1-C2 in FIG. 19A, respectively.

As illustrated in FIG. 19A to FIG. 19D, the flexible battery 10 includes an exterior body 11 and a battery cell 12 with a stacked-layer structure stored in the exterior body 11. As illustrated in FIG. 19A, the flexible battery 10 includes a current collector 13a and a current collector 13b that are electrically connected to the battery cell 12 with a stacked-layer structure and that extend to the outside of the exterior body 11. In addition to the battery cell 12 with a stacked-layer structure, an electrolyte solution is sealed in the exterior body 11.

As illustrated in FIG. 19A, FIG. 19C, and FIG. 19D, the exterior body 11 has a wave shape and is folded in half so as to hold the battery cell 12 with a stacked-layer structure. The exterior body 11 includes a pair of portions 31 overlapping with the battery cell 12 with a stacked-layer structure, a folded portion 32, a pair of bonding portions 33, and a bonding portion 34. The pair of bonding portions 33 is belt-like portions extending in the direction substantially perpendicular to the folded portion 32 and is provided with the portion 31 therebetween. The bonding portion 34 is a belt-like portion located opposite to the folded portion 32 with the portion 31 therebetween. The portion 31 can also be referred to as a region surrounded by the folded portion 32, the pair of bonding portions 33, and the bonding portion 34. Here, FIG. 19A to FIG. 19C and the like illustrate an example in which the current collector 13a and the current collector 13b are partly held by the bonding portion 34.

The portion 31 of the exterior body 11 has a wave shape in which crest lines 21 and trough lines 22 are alternately repeated. In FIG. 19A, the crest lines 21 connecting the tops of projections are shown by dashed-dotted lines, and the trough lines 22 connecting the bottoms of depressions are shown by broken lines. In FIG. 19C and FIG. 19D, circles are added to parts of the crest lines 21 and parts of the trough lines 22. In other words, at least the surface of the portion 31 has a wave shape in which projections and depressions are repeated in the direction in which the pair of bonding portions 33 extends.

In a plan view, the length of the bonding portion 33 in the extending direction is greater than the length in the direction parallel to the extending direction of the bonding portion 33. As illustrated in FIG. 19A, a portion of the folded portion 32 that is located closest to the bonding portion 34 is closer to the bonding portion 34 by a distance L1 from a line connecting end portions of the pair of bonding portions 33 on the folded portion 32 side.

The battery cell 12 with a stacked-layer structure has a structure in which at least positive electrodes and negative electrodes are alternately stacked. The battery cell 12 with a stacked-layer structure is also referred to as an electrode stack in some cases. Separators may be provided between each of the positive electrodes and each of the negative electrodes. A larger number of stacks of the battery cell 12 with a stacked-layer structure can increase the capacity of the flexible battery 10. For details of the battery cell 12 with a stacked-layer structure, the above embodiment can be referred to.

The thickness of the battery cell 12 with a stacked-layer structure is, for example, greater than or equal to 500 μm and less than or equal to 9 mm, preferably greater than or equal to 400 μm and less than or equal to 3 mm, further preferably greater than or equal to 200 μm and less than or equal to 2 mm, and is typically approximately 1.5 mm.

As illustrated in FIG. 19A, FIG. 19C, and FIG. 19D, a space 25 is included between the folded portion 32 and an end of the battery cell 12 with a stacked-layer structure inside the exterior body 11. Here, the length of the space 25 in the direction parallel to the extending direction of the bonding portion 33 is represented by a distance d0. The distance d0 can also be referred to as the distance between the end of the battery cell 12 with a stacked-layer structure and the interior surface of the exterior body 11 that is located in the folded portion 32.

In the bonding portion 34, the exterior body 11 is bonded to the current collector 13a (and the current collector 13b) that extends inside and outside of the exterior body 11. Hence, the battery cell 12 with a stacked-layer structure is fixed to a position relative to the exterior body 11. The current collector 13a is one of a negative electrode current collector and a positive electrode current collector included in the battery cell 12 with a stacked-layer structure, and the current collector 13b is the other of the negative electrode current collector and the positive electrode current collector. Note that one and the other are just examples and may be replaced with each other as an example. Furthermore, a tab using metal foil or the like may be provided instead of the current collector 13a and the current collector 13b. In the bonding portion 34, the exterior body 11 and the tab are bonded to each other, and the battery cell 12 with a stacked-layer structure is fixed to the exterior body 11.

Furthermore, as illustrated in FIG. 19A, FIG. 19C, and FIG. 19D, the portion 31 of the exterior body 11 preferably has a region where the projections closer to the folded portion 32 have longer periods and smaller heights. The flexible battery 10 is fabricated to have such an exterior body, and the space 25 is formed inside the exterior body 11.

As illustrated in FIG. 19C and FIG. 19D, the projections in the pair of portions 31 overlapping with the battery cell 12 with a stacked-layer structure face each other so as to have a 180-degree phase shift. In other words, the exterior body 11 may be folded so that the crest lines 21 overlap with each other and the trough lines 22 overlap with each other with the battery cell 12 with a stacked-layer structure therebetween. As a result, the large space 25 can be obtained.

### [Space]

Next, the bent form of the battery provided with the space 25 will be described.

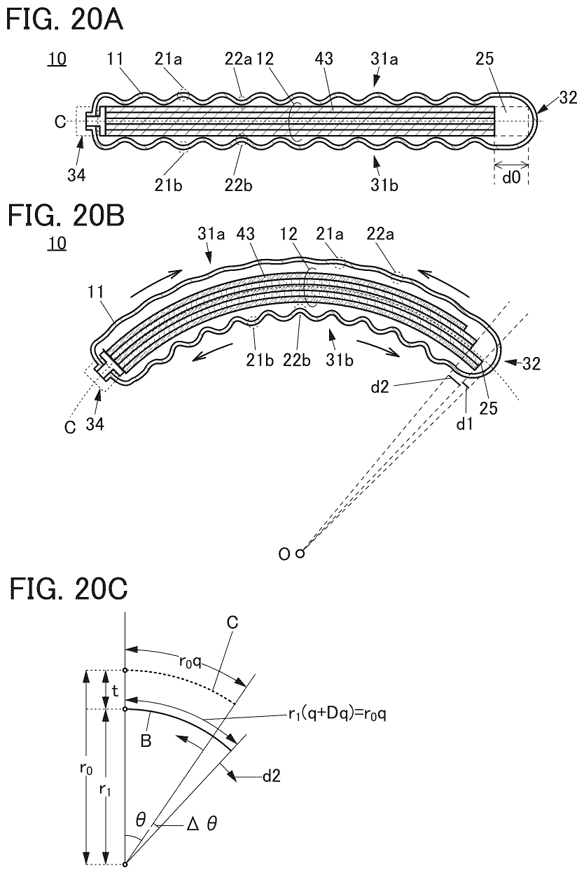

FIG. 20A is a schematic cross-sectional view illustrating simplified part of the structure of the flexible battery 10.

Here, the pair of portions 31 of the exterior body 11 is distinguished from each other and shown as a portion 31a and a portion 31b. Similarly, respective crest lines and respective trough lines of the portion 31a and the portion 31b are shown as a crest line 21a and a crest line 21b, and a trough line 22a and a trough line 22b.

In FIG. 20A, the battery cell 12 with a stacked-layer structure has a structure in which five electrodes 43 are stacked. The electrodes 43 correspond to the negative electrode and the positive electrode in the above embodiment. The battery cell 12 with a stacked-layer structure is fixed to the exterior body 11 in the bonding portion 34.

Inside the exterior body 11, the space 25 is provided in the vicinity of the folded portion 32. Here, the distance between the inner wall of the exterior body 11 and an end of the electrode 43 when the exterior body 11 is not bent is assumed to be the distance d0.

A neutral plane of the flexible battery 10 is referred to as a neutral plane C. Here, the neutral plane C corresponds to the neutral plane of the electrode 43 that is located in the middle of the five electrodes 43 included in the battery cell 12 with a stacked-layer structure.

FIG. 20B is a schematic cross-sectional view of the flexible battery 10 that is bent in an arc shape around a point O. Here, the flexible battery 10 is bent so that the portion 31a is on the outer side and the portion 31b is on the inner side.

As illustrated in FIG. 20B, the portion 31a that is on the outer side is changed in shape such that the projection height becomes smaller and the projection period becomes longer. That is, the distance between the crest lines 21a and the distance between the trough lines 22b of the portion 31a that is on the outer side increase. In contrast, the portion 31b that is on the inner side is changed in shape such that the projection height becomes larger and the projection period becomes shorter. That is, the distance between the crest lines 21b and the distance between the trough lines 22b of the portion 31b that is on the inner side decrease after bending. When the portion 31a and the portion 31b are changed in shape in such a manner, stress applied to the exterior body 11 is relieved, and the flexible battery 10 can be bent without any damage to the exterior body 11.

As illustrated in FIG. 20B, a plurality of electrodes 43 are changed in shape so as to be shifted relative to one another. This relieves stress applied to the battery cell 12 with a stacked-layer structure, allowing the flexible battery 10 to be bent without any damage to the battery cell 12 with a stacked-layer structure. When the thickness of the electrode 43 is set sufficiently small with respect to the curvature radius with which the flexible battery 10 is bent, less stress is applied to the electrodes 43 themselves. It is assumed in FIG. 20B that the electrodes 43 themselves do not stretch with bending.

Ends of the electrodes 43 among the plurality of electrodes 43 that are located outward from the neutral plane C are shifted to the bonding portion 34 side. In contrast, ends of the electrodes 43 that are located inward from the neutral plane C are shifted to the folded portion 32 side. Here, the distance between the inner wall of the exterior body 11 and the end portion of the innermost electrode 43 on the folded portion 32 side decreases from the distance d0 to a distance d1 in bending. Here, the amount of relative deviation between the electrode 43 located on the neutral plane C and the innermost electrode 43 is assumed to be a distance d2. The distance d1 is equal to a value obtained by subtracting the distance d2 from the distance d0.

In the case where the distance d0 before bending is smaller than the distance d2 after bending, the electrodes 43 of the battery cell 12 with a stacked-layer structure that are located inward from the neutral plane C touch the inner wall of the exterior body 11. Thus, a required value of the distance d0 will be described below.

Description will be given below with reference to FIG. 20C. In FIG. 20C, a curve corresponding to the neutral plane C is shown by a dashed line, and a curve corresponding to the innermost surface of the battery cell 12 with a stacked-layer structure is shown as a curve B by a solid line. The arc angle of the curve C is assumed to be θ, and the arc angle of the curve B is assumed to be θ+Δθ.

A curve C is the arc with a radius r₀, and a curve B is the arc with a radius r₁. The difference between the radius r₀ and the radius r₁ is assumed to be t. Here, t is equivalent to half of the thickness of the battery cell 12 with a stacked-layer structure. The arc lengths of the curve C and the curve B are equal to each other.

The distance d2, which is the amount of difference between an end portion of the curve C and that of the curve B, is calculated from the above relation as follows.

$$\begin{matrix}d 2 = {r}_{1} \times Δ θ \\ = t \times θ\end{matrix} \qquad [ Formula 1 ]$$

This indicates that the distance d2 can be estimated from the thickness of the battery cell 12 with a stacked-layer structure and the bending angle and does not depend on the length of the battery cell 12 with a stacked-layer structure and the bending curvature radius, for example.

Setting the distance d0 of the space 25 larger than or equal to the distance d2 as described above can prevent the battery cell 12 with a stacked-layer structure and the exterior body 11 from touching each other when the flexible battery 10 is bent. Thus, in the case where the flexible battery 10 with a thickness of 2t is used while being bent and the maximum angle at which the flexible battery 10 is bent is θ, the distance d0 between the battery cell 12 with a stacked-layer structure and the inner wall of the exterior body 11 in the space 25 is set to a value greater than or equal to t×θ.

For example, when the battery cell is used while being bent at 30°, the distance d0 of the space 25 is set to a value greater than or equal to πt/6. Similarly, when the battery is used while being bent at 60°, the distance d0 is set to a value greater than or equal to πt/3; when the battery is used while being bent at 90°, the distance d0 is set to a value greater than or equal to πt/2; and when the battery is used while being bent at 180°, the distance d0 is set to a value greater than or equal to πt.

For example, in the case where the flexible battery 10 is not used in the state of being wound, the maximum bending angle of the flexible battery 10 is estimated to be 180°. Thus, when the flexible battery 10 is used in such a manner, the distance d0 is set to a value larger than or equal to πt, preferably larger than πt, whereby the flexible battery 10 can be used for all devices. The flexible battery 10 can be provided in a variety of electronic devices in which the flexible battery 10 is used while being bent to have a V shape or a U shape, for example, the flexible battery 10 is used while being folded in half.

In the case where the flexible battery 10 is wound so as to circle around a cylindrical object once, the distance d0 of the space 25 is set to a value larger than or equal to 2πt so that the flexible battery 10 can be bent at 360°. In the case where the flexible battery 10 is wound so as to circle around a cylindrical object more than once, the distance d0 of the space 25 is set to an appropriate value accordingly. In the case where the flexible battery 10 is changed in shape to have a bellows shape, the distance d0 of the space 25 is set to an appropriate value depending on the direction, the angle, and the number of bending portions of the flexible battery 10.

The above is the description of the space 25.

### Manufacturing Method Example

An example of a method for manufacturing the flexible battery 10 will be described below.

First, a flexible film to be the exterior body 11 is prepared.

For the film, a material with high water resistance and high gas resistance is preferably used. As the film used as the exterior body, a layered film in which a metal film and an insulator film are stacked is preferably used. The metal film can be formed using any of the metals that can have the form of metallic foil, such as aluminum, stainless steel, nickel steel, gold, silver, copper, titanium, chromium, iron, tin, tantalum, niobium, molybdenum, zirconium, and zinc, or an alloy thereof. As the insulator film, a single-layer film selected from a plastic film made of an organic material, a hybrid material film containing an organic material (e.g., an organic resin or fiber) and an inorganic material (e.g., ceramics), and a carbon-containing inorganic film (e.g., a carbon film or a graphite film), or a layered film including two or more of the above films can be used. A metal film is easily embossed. Forming projections by embossing increases the surface area of the film exposed to outside air, achieving efficient heat dissipation.

Then, the flexible film is processed by, for example, embossing to form the exterior body 11 having a wave shape.

The projections and depressions of the film can be formed by pressing (e.g., embossing). In the projections and depressions formed on the film by embossing, an enclosed space whose inner volume is variable is formed with the film serving as part of a wall of a sealing structure. This enclosed space can be said to be formed because the film has an accordion structure or a bellows structure. The sealing structure using the film can prevent entry of water and dust. Note that embossing, which is a kind of pressing, is not necessarily employed and any method that allows formation of a relief on part of the film may be employed. A combination of methods, for example, embossing and any other pressing, may be performed on one film. Embossing may be performed on one film more than once.

The projections of the film can have a hollow semicircular shape, a hollow semi-oval shape, a hollow polygonal shape, or a hollow irregular shape. In the case of a hollow polygonal shape, the polygon preferably has more than three corners, in which case stress concentration at the corners can be reduced.

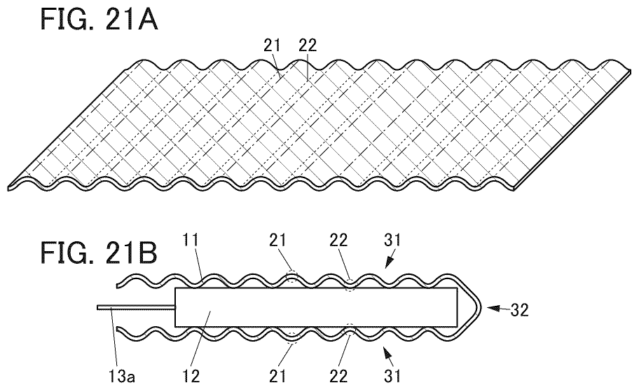

FIG. 21A is an example of a schematic perspective view of the exterior body 11 formed in such a manner. The exterior body 11 has a wave shape in which the plurality of crest lines 21 and the plurality of trough lines 22 are alternately arranged on its surface which is the outer side of the flexible battery 10. Here, the crest lines 21 adjacent to each other and the trough lines 22 adjacent to each other are preferably arranged at regular intervals.

Subsequently, the exterior body 11 is partly folded such that the battery cell 12 with a stacked-layer structure prepared in advance is sandwiched (FIG. 21B). At this time, the length of the exterior body 11 is preferably adjusted such that the current collector 13a or the like connected to the battery cell 12 with a stacked-layer structure is exposed to the outside. Furthermore, portions of the exterior body 11 that protrude beyond the battery cell 12 serve as the bonding portion 33 and the bonding portion 34 later; thus, the protruding portions are set sufficiently long in consideration of the thickness of the battery cell 12 with a stacked-layer structure.

FIG. 21B illustrates an example of the case where the pair of portions 31 between which the battery cell 12 with a stacked-layer structure is positioned is located such that the waves of the portions 31 have a 180-degree phase shift. In other words, FIG. 21B illustrates the case where the exterior body 11 is bent such that the crest lines 21 overlap with each other and the trough lines 22 overlap with each other in the pair of portions 31.

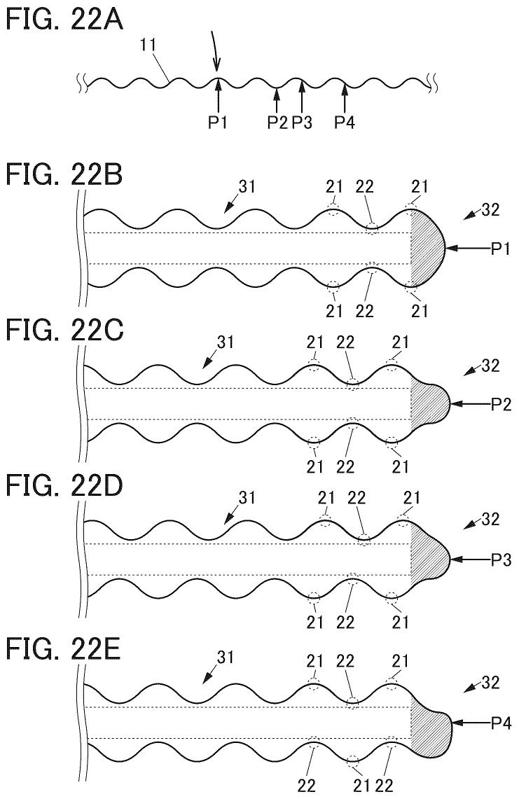

Here, the position and the shape of the folded portion of the exterior body 11 will be described. FIG. 22A is a schematic cross-sectional view of the exterior body 11. FIG. 22B to FIG. 22E each illustrate a cross-sectional shape of the folded portion 32 that is folded at a point P1 to a point P4 in FIG. 22A. Note that in this description, the exterior body 11 is folded while being pressed in the direction shown by an arrow illustrated in FIG. 22A; thus, the lower surface of the exterior body 11 in FIG. 22A corresponds to the outer surface of the flexible battery 10. Hence, in FIG. 22A, a portion protruding upward is shown as the trough line 22 and a portion protruding downward is shown as the crest line 21.

In FIG. 22B to FIG. 22E, a region surrounded by the folded portion 32 is hatched. Here, the folded portion 32 is a region sandwiched between two positions at which the wave periodicity of the exterior body 11 is lost. Note that since the shape of the folded portion 32 is exaggerated in FIG. 22B to FIG. 22E and the like, its perimeter is not shown correctly in some cases.

The point P1 coincides with the trough line 22. As illustrated in FIG. 22B, the folded portion 32 can have a substantially arc shape by bending at the point P1. In addition, bending at the point P1 allows the phases of opposite waves to be shifted by 180°.

The point P2 coincides with the crest line 21. As illustrated in FIG. 22C, the folded portion 32 can have a substantially arc shape by bending at the point P2. In addition, bending at the point P2 allows the phases of opposite waves to be shifted by 180°.

The point P3 is a point located between the crest line 21 and the trough line 22 and closer to the crest line 21 than to the midpoint of the crest line 21 and the trough line 22. As illustrated in FIG. 22D, the point P3 coincides with neither the crest line 21 nor the trough line 22, whereby the shape of the folded portion 32 is distorted instead of being vertically symmetrical. Bending at the point P3 allows bending so as to avoid coincidence of the crest lines, the trough lines, and the crest line and the trough line of opposite waves.

The point P4 coincides with the midpoint of the crest line 21 and the trough line 22. As illustrated in FIG. 22E, bending at the point P4 causes the shape of the folded portion 32 to be significantly distorted. Specifically, the folded portion 32 is more likely to protrude upward or downward. Therefore, it is difficult to ensure a large distance between one end of the battery cell 12 with a stacked-layer structure and the inner wall of the exterior body 11.

Here, FIG. 22B, FIG. 22C, and FIG. 22D are the same in that one crest line 21 is located between the folded portion 32 and the trough line 22 of the portion 31 that is closest to the folded portion 32. In particular, FIG. 22B illustrates an example of the case where boundaries of the folded portion 32 coincide with the crest lines 21 of the waves. The exterior body 11 is folded with the crest lines 21 or the vicinities thereof regarded as boundaries in this manner, whereby a space that is large in the thickness direction can be ensured on the inner side of the folded portion 32 and the vicinity thereof. Such a shape allows the distance between the inner wall of the exterior body 11 and the outermost battery cell 12 to be kept large when the flexible battery 10 is folded, which is important as described above.

In contrast, in FIG. 22E, there is no crest line 21 between the folded portion 32 and the trough line 22 of the portion 31 that is closest to the folded portion 32, on the lower surface side. Thus, a space that is large in the thickness direction is unlikely to be formed in the folded portion 32 and the vicinity thereof.

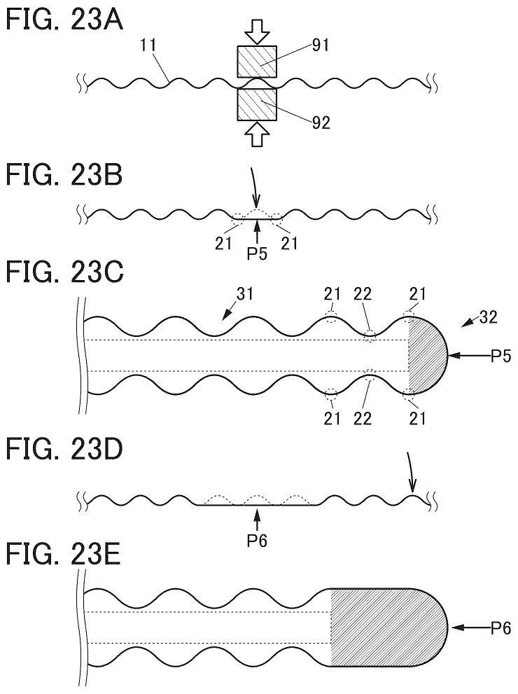

Here, a portion of the exterior body 11 that is to be the folded portion 32 preferably has a flat shape instead of a wave shape. For example, as illustrated in FIG. 23A, the exterior body 11 is partly planarized by being sandwiched by a mold 91 and a mold 92 each with a flat surface and pressurized or by being pressurized while being heated.

FIG. 23B is a schematic cross-sectional view of the exterior body 11 partly planarized in this manner. Here, the exterior body 11 is partly planarized such that the crest lines 21 are connected.

FIG. 23C is a schematic cross-sectional view of the exterior body 11 folded at a center point P5 of the formed flat portion by being pressed at the point P5 in the direction shown by an arrow. As illustrated in FIG. 23C, when the planarized exterior body 11 is used for the folded portion 32, a space larger than that in FIG. 22B can be formed.

FIG. 23D and FIG. 23E each illustrate an example of the case where planarization is performed in a region larger than that in FIG. 23C. As in FIG. 23B, the exterior body 11 is partly planarized such that the crest lines 21 are connected. When the exterior body 11 is planarized in a region larger than the thickness of the battery cell 12 with a stacked-layer structure in such a manner, a large space that is uniform in the thickness direction can be formed.

The above is the description of the relation between the position and the shape of the folded portion.

### [Film Processing Method]

Next, a processing method of a film that can be used for the exterior body 11 will be described.

First, a film made of a flexible material is prepared. The film preferably has a stacked body, and a metal film including a heat-seal layer on one surface or both surfaces is used. As an adhesive layer, a heat-seal resin film containing polypropylene, polyethylene, or the like is used. In this embodiment, a film in which a surface of aluminum foil is provided with a nylon resin and the rear surface of the aluminum foil is provided with a stack of an acid-proof polypropylene film and a polypropylene film is used as the film. The film is cut to obtain a desired size.

Then, the film is embossed, so that the film with projections and depressions can be obtained. The film includes a plurality of projections and depressions, thereby having a wave pattern that can be visually recognized. Although the film is cut and then embossed in this example, there is no particular limitation on the order; embossing may be performed before cutting the film and then the film is cut. Alternatively, the film may be cut after thermocompression bonding is performed with the film folded.

Embossing, which is a kind of pressing, will be described below.

FIG. 24 is a cross-sectional view illustrating an example of embossing. Note that embossing, which is a kind of pressing, refers to processing for forming projections and depressions corresponding to projections and depressions of an embossing roll on a film by bringing the embossing roll whose surface has projections and depressions into contact with the film with pressure. Note that the embossing roll is a roll whose surface is patterned.

FIG. 24 illustrates an example in which both surfaces of a film are embossed. This example shows a manufacturing process of a film having projections whose top portions are on one surface side.

FIG. 24 illustrates the state where a film 90 is sandwiched between an embossing roll 95 in contact with one surface of the film and an embossing roll 96 in contact with the other surface and the film 90 is being transferred in a direction 60. The surface of the film is patterned by pressure or heat. The surface of the film may be patterned by pressure and heat.

As the embossing roll, a metal roll, a ceramic roll, a plastic roll, a rubber roll, an organic resin roll, a lumber roll, or the like can be used as appropriate.

In FIG. 24, embossing is performed using the male embossing roll 96 and the female embossing roll 95. The male embossing roll 96 has a plurality of projections 96a. The projections correspond to projections formed on a film to be processed. The female embossing roll 95 has a plurality of projections 95a. Between adjacent projections 95a, a depression is positioned into which a projection formed on the film by the projection 96a of the male embossing roll 96 fits.

Successive embossing by which the film 90 partly stands out and debossing by which the film 90 is partly indented can form a projection and a flat portion successively. In this manner, a pattern can be formed on the film 90.

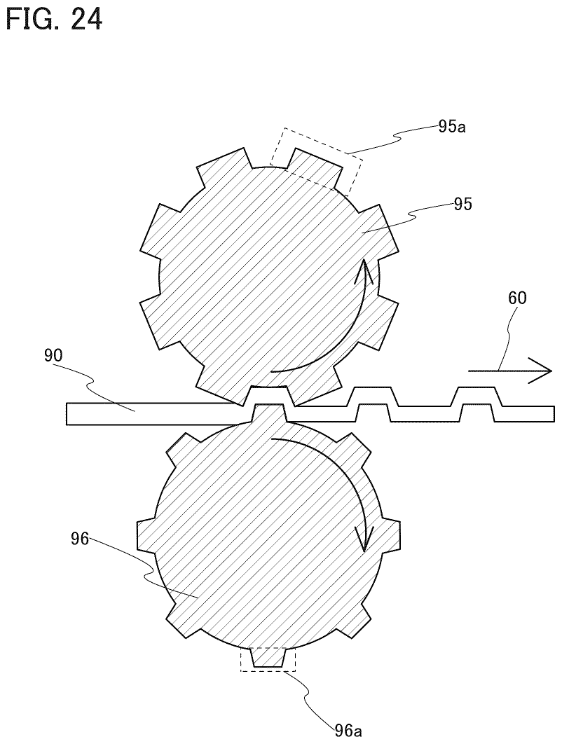

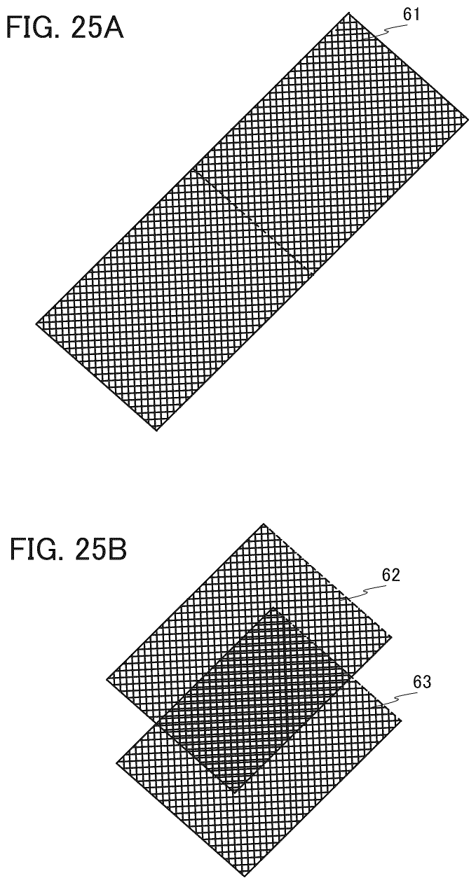

FIG. 25A and FIG. 25B are bird's eye views illustrating the completed shapes obtained by performing the embossing illustrated twice with different orientations of the film 90. Note that a region subjected to thermocompression bonding is not necessarily embossed. Specifically, embossing is performed on the film 90 in a first direction, and then embossing is performed on the film 90 in a second direction that is rotated 90° with respect to the first direction, whereby a film 61 to a film 63 having an embossed shape (also referred to as an alternating wave shape) illustrated in FIG. 25A and FIG. 25B can be obtained. Note that when a flexible battery is fabricated using one film 61, the film 61 having an alternating wave shape has an external shape illustrated in FIG. 25A and can be used by being folded in half along a dashed line portion. When a flexible battery is fabricated using two films (the film 62 and the film 63), the plurality of films (the film 62 and the film 63) each having an alternating wave shape have an external shape illustrated in FIG. 25B, and the film 62 and the film 63 can overlap with each other to be used.

When processing is performed using the embossing rolls in the aforementioned manner, an apparatus can be small. Furthermore, a film before being cut can be processed, achieving excellent productivity. Note that a film processing method is not limited to processing using embossing rolls; a film may be processed by pressing a pair of embossing plates having a surface with projections and depressions against the film. In that case, one of the embossing plates may be flat and the film may be processed in a plurality of steps.

In the above-described structure example of the flexible battery, the example is described in which the exterior body on one surface of the flexible battery and the exterior body on the other surface thereof have the same embossed shape; however, the structure of the flexible battery of one embodiment of the present invention is not limited thereto. For example, a flexible battery one surface of which is provided with an exterior body having an embossed shape and the other surface of which is provided with an exterior body not having an embossed shape can be used. Alternatively, the exterior body on one surface of the flexible battery and the exterior body on the other surface thereof may have different embossed shapes.

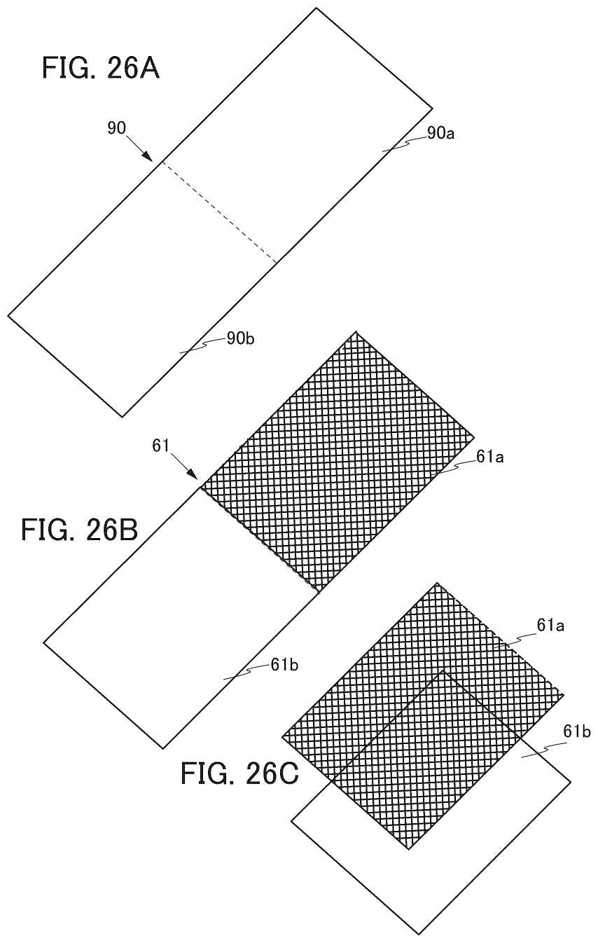

A flexible battery one surface of which is provided with an exterior body having an embossed shape and the other surface of which is provided with an exterior body not having an embossed shape will be described with reference to FIG. 26 to FIG. 28.

First, a film made of a flexible material is prepared. The film has a stacked-layer structure in which an adhesive layer (also referred to as a heat-seal layer) is provided on one or both surfaces of a metal film. As the adhesive layer, a heat-seal resin film containing polypropylene, polyethylene, or the like is used. In this embodiment, a metal film in which a surface of aluminum foil is provided with a nylon resin and the rear surface of the aluminum foil is provided with a stack of an acid-proof polypropylene film and a polypropylene film is used as the film. This sheet is cut to prepare the film 90 illustrated in FIG. 26A.

Then, part of the film 90 (a film 90a) is embossed and a film 90b is not embossed. As a result, the film 61 illustrated in FIG. 26B is formed. As illustrated in FIG. 26B, projections and depressions are formed on a surface of a film 61a to form a visually recognizable pattern and projections and depressions are not formed on a surface of a film 61b. There is a boundary between the film 61a provided with projections and depressions and the film 61b not provided with projections and depressions. In FIG. 26B, the film 61a is an embossed portion of the film 61, and the film 61b is a non-embossed portion. Note that embossing for the film 61a may be performed to provide the same projections and depressions on the entire surface, or may be performed to provide two or more types of different projections and depressions depending on the portions of the film 61a. In the case of providing two or more types of different projections and depressions, a boundary is formed between any two different types of projections and depressions.

The entire surface of the film 90 in FIG. 26A may be embossed. Note that embossing for the film 61 may be performed to provide the same projections and depressions on the entire surface, or may be performed to provide two or more types of different projections and depressions depending on the portions of the film 61. In the case of providing two or more types of different projections and depressions, a boundary is formed between any two different types of projections and depressions. Alternatively, as illustrated in FIG. 26C, the film 61a whose surface has projections and depressions and the film 61b whose surface does not have projections and depressions may be prepared.

Although the film is cut and then embossed in this example, there is no particular limitation on the order; embossing may be performed before cutting the film and then the film is cut to be in the state illustrated in FIG. 26B. Alternatively, the film may be cut after thermocompression bonding is performed with the film folded.

In this embodiment, projections and depressions are provided on both surfaces of part of the film 90 (the film 90a) so that the film 61 having a pattern is formed, and the film 61 is folded at the center such that two end portions overlap with each other, and is sealed on three sides with an adhesive layer. Here, the film 61 is referred to as the exterior body 11.

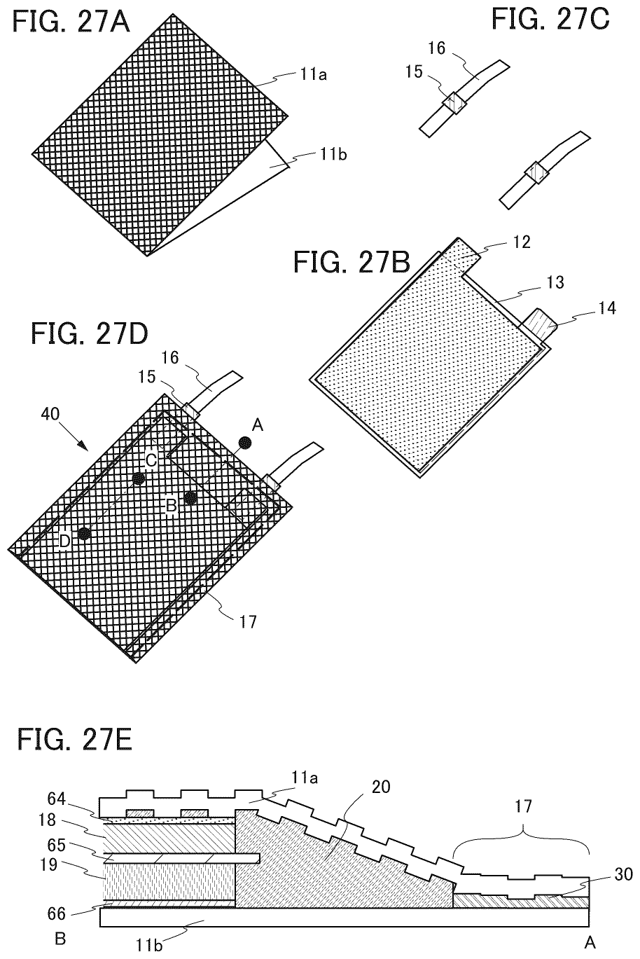

Next, the exterior body 11 is folded along a dotted line in FIG. 26B to be in the state illustrated in FIG. 27A. FIG. 27B illustrates a positive electrode 12, a separator 13, and a negative electrode 14, and FIG. 27C illustrates a lead electrode 16 including a sealing layer 15. FIG. 27E illustrates an example of a cross section taken along the dashed-dotted line A-B in FIG. 27D.

As illustrated in FIG. 27D and FIG. 27E, a stack including a positive electrode current collector 64 on the surface of which a positive electrode active material layer 18 is partly formed, a separator 65, and a negative electrode current collector 66 on the surface of which a negative electrode active material layer 19 is partly formed is prepared to constitute a flexible battery. Here, for simple description, an example is described in which one stack including the positive electrode current collector 64 provided with the positive electrode active material layer 18, the separator 65, and the negative electrode current collector 66 provided with the negative electrode active material layer 19 is held in an exterior body; however, to increase the capacity of a flexible battery, a plurality of the stacks may be held in an exterior body.

Then, two lead electrodes 16 including sealing layers 15 illustrated in FIG. 27C are prepared. The lead electrodes 16 are each also referred to as a lead terminal and provided to lead a positive electrode or a negative electrode of a flexible battery to the outside of an exterior body. As the lead electrodes, aluminum and nickel-plated copper are used for a positive electrode lead and a negative electrode lead, respectively.

Then, a positive electrode lead electrode is electrically connected to a protruding portion of the positive electrode current collector 64 by ultrasonic welding or the like. A negative electrode lead electrode is electrically connected to a protruding portion of the negative electrode current collector 66 by ultrasonic welding or the like.

Then, two sides of the exterior body 11 are sealed by thermocompression bonding, and one side is left open for introduction of an electrolyte solution (hereinafter, the shape of the exterior body in this state is also referred to as a bag-like shape). In thermocompression bonding, the sealing layers 15 provided over the lead electrodes are also melted, thereby fixing the lead electrodes and the exterior body 11 to each other. After that, in reduced pressure or an inert atmosphere, a desired amount of electrolyte solution is dripped into the exterior body 11 having a bag-like shape. Lastly, the outer edge of the exterior body 11 that has not been subjected to thermocompression bonding and is left open is sealed by thermocompression bonding.

In this manner, the flexible battery 40 illustrated in FIG. 27D can be manufactured.

As illustrated in FIG. 27E, a stack including the positive electrode current collector 64, the positive electrode active material layer 18, the separator 65, the negative electrode active material layer 19, and the negative electrode current collector 66 in this order is held by the folded exterior body 11, an end portion is sealed with an adhesive layer 30, and the other space inside the folded exterior body 11 includes an electrolyte solution 20. The proportion of the volume of the battery cell to the total volume of the flexible battery is preferably greater than or equal to 50%.

In the flexible battery 40, the surface of the film 90 serving as an exterior body has a pattern of projections and depressions. A region between a dotted line and an end portion in FIG. 27D is a thermocompression-bonded region 17, and its surface also has a pattern of projections and depressions. Although the projections and depressions in the thermocompression-bonded region 17 are smaller than those in a center portion, they can relieve stress applied when the flexible battery is bent. That is, projections and depressions of an exterior body 11a are different between a region overlapping with the positive electrode current collector 64 and the thermocompression-bonded region 17.

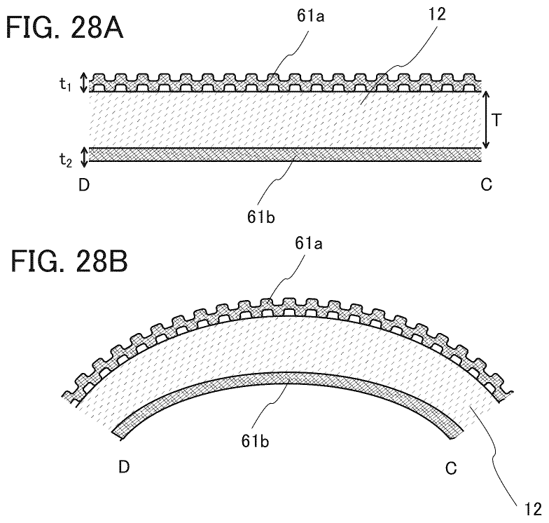

FIG. 28A and FIG. 28B are cross-sectional views taken along the dashed-dotted line C-D of the flexible battery in FIG. 27D. FIG. 28A illustrates the battery cell 12 with a stacked-layer structure in the battery cell, the embossed film 61a that covers the top surface of the battery cell, and the non-embossed film 61b that covers the bottom surface of the battery cell. For simplification of the drawings, the electrolyte solution and the stacked-layer structure of the positive electrode current collector provided with the positive electrode active material layer, the separator, the negative electrode current collector provided with the negative electrode active material layer, and the like are collectively illustrated as the battery cell 12 with a stacked-layer structure in the battery cell. Note that T represents the thickness of the battery cell 12 with a stacked-layer structure in the battery cell, t₁ represents the sum of the embossing depth and the thickness of the embossed film 61a that covers the top surface of the battery cell, and t₂ represents the sum of the thickness of the non-embossed film 61b and the embossing depth and the thickness of the embossed film 61b that cover the bottom surface of the battery. At this time, the total thickness of the flexible battery becomes T+t1+t2. Given that T≥t1+t2, the proportion of the volume of the battery cell 12 with a stacked-layer structure to the total volume of the flexible battery can be greater than or equal to 50%.

The adhesive layer 30, which is only partly illustrated in FIG. 27E; a layer made of polypropylene is provided on the surface of the film that is to be attached, and only a thermocompression-bonded portion becomes the adhesive layer 30.

FIG. 27E illustrates an example in which the bottom side of the exterior body 11 is fixed and pressure bonding is performed. In this case, the top side is greatly bent and a step is formed; thus, when a plurality of the above-described stacks, e.g., eight or more stacks, are held by the folded exterior body 11, the step is large and stress might be excessively applied to the top side of the exterior body 11a. Furthermore, the end portion of the upper film might be greatly misaligned with the end portion of the lower film. In that case, to prevent misalignment of the end portions, a step may be provided on the lower film and pressure bonding may be performed at the center so that stress is equalized.

In the case where the misalignment is large, there is a region where part of the end portion of one film does not overlap with the other film. This region may be cut off to correct the misalignment of the end portions of the upper and lower films.

The contents of this embodiment can be freely combined with the contents in the other embodiments.

### Embodiment 4

In this embodiment, a structure example of the battery cell used in the above embodiments will be described.

### [Negative Electrode]

A negative electrode includes a negative electrode active material layer and a negative electrode current collector. The negative electrode active material layer includes a negative electrode active material and may further contain a conductive material and a binder.

Metal foil can be used as the current collector, for example. The negative electrode can be formed by applying slurry onto the metal foil and drying. Note that pressing may be performed after drying. The negative electrode is obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry; in some cases, slurry for forming a negative electrode active material layer is referred to as slurry for a negative electrode.

### <Negative Electrode Active Material>

As the negative electrode active material, for example, a carbon material or an alloy-based material can be used.

As the carbon material, for example, graphite (natural graphite and artificial graphite), graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of a lithium metal.

Non-graphitizing carbon can be obtained by baking a synthetic resin such as a phenol resin, and an organic substance of plant origin, for example. In non-graphitizing carbon contained in the negative electrode active material of the lithium-ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N is preferable because of its high discharge capacity (900 mAh/g and 1890 mAh/cm³).

A nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride of lithium and a transition metal can be used as the negative electrode active material by extracting the lithium ions contained in the positive electrode active material in advance.

A material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Note that one kind or a combination of various kinds of the negative electrode active materials described above can be used. For example, a combination of a carbon material and silicon or a combination of a carbon material and silicon monoxide can be used.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide or, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a “passivation film” refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Conductive Material>

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of an active material surface, the case where a conductive material is embedded in projections and depressions of an active material surface, and the case where an active material and a conductive material are electrically connected to each other without being in contact with each other.

An active material layer such as the positive electrode active material layer or the negative electrode active material layer preferably contains a conductive material.

As the conductive material, for example, carbon black such as acetylene black or furnace black can be used. Graphite such as artificial graphite or natural graphite can also be used as the conductive material. As the conductive material, carbon fiber such as carbon nanofiber or carbon nanotube can be used. The graphene or graphene compound described in the above embodiment can also be used as the conductive material. One or two or more of the above materials can be mixed and used as the conductive material.

As the carbon fiber, for example, carbon fiber such as mesophase pitch-based carbon fiber or isotropic pitch-based carbon fiber can be used. Carbon nanofiber, carbon nanotube, or the like can also be used as the carbon fiber. Carbon nanofiber or carbon nanotube can be formed by, for example, a vapor deposition method.

Metal powder or metal fiber of copper, nickel, aluminum, silver, gold, or the like, a conductive ceramic material, or the like may be included as the conductive material.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, graphene or a graphene compound is capable of making low-resistance surface contact; accordingly, the electrical conduction between the particulate active material and the graphene or graphene compound can be improved with a smaller amount of the graphene or graphene compound than that of a normal conductive material. This can increase the proportion of the active material in the active material layer. Accordingly, the discharge capacity of a battery cell can be increased.

Carbon black or carbon fiber easily enters a microscopic space. A microscopic space means, for example, a region or the like between a plurality of active materials. When carbon black or carbon fiber that easily enters a microscopic space and graphene or a graphene compound that is capable of making surface contact are used in combination, the density of the electrode is increased and an excellent conductive path can be formed.

### <Current Collector>

As the current collector, a highly conductive material which is not alloyed with a carrier ion such as lithium, for example, a metal such as stainless steel, gold, platinum, zinc, iron, copper, aluminum, or titanium, or an alloy thereof can be used. The current collector can have a sheet-like shape, a net-like shape, a punching-metal shape, an expanded-metal shape, or the like as appropriate. The current collector preferably has a thickness greater than or equal to 5 μm and less than or equal to 30 μm.

Note that a material that is not alloyed with carrier ions of lithium or the like is preferably used for the negative electrode current collector.

[Positive Electrode]

A positive electrode includes a positive electrode active material layer and a positive electrode current collector. The positive electrode active material layer includes a positive electrode active material and may further contain at least one of a conductive material and a binder. Note that the positive electrode current collector, the conductive material, and the binder described in [Negative electrode] can be used.

Metal foil can be used as the current collector, for example. The positive electrode can be formed by applying slurry onto the metal foil and drying. Note that pressing may be performed after drying. The positive electrode is obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode.

### <Positive Electrode Active Material>

As the positive electrode active material, one or more of a composite oxide having a layered rock-salt structure, a composite oxide having an olivine structure, and a composite oxide having a spinel structure can be used.

As the composite oxide having a layered rock-salt structure, one or more of lithium cobalt oxide, lithium nickel-cobalt-manganese oxide, lithium nickel-cobalt-aluminum oxide, and lithium nickel-manganese-aluminum oxide can be used. Note that the composition formula can be represented by LiM1O₂ (M1 is one or more selected from nickel, cobalt, manganese, and aluminum), and a coefficient of the composition formula is not limited to an integer.

As the lithium cobalt oxide, for example, lithium cobalt oxide to which magnesium and fluorine are added can be used. It is preferable to use lithium cobalt oxide to which magnesium, fluorine, aluminum, and nickel are added.

As the lithium nickel-cobalt-manganese oxide, for example, lithium nickel-cobalt-manganese oxide with a ratio such as nickel:cobalt:manganese=1:1:1, 6:2:2, 8:1:1, or 9:0.5:0.5 can be used. As the above-described lithium nickel-cobalt-manganese oxide, for example, lithium nickel-cobalt-manganese oxide to which one or more of aluminum, calcium, barium, strontium, and gallium are added is preferably used.

As the composite oxide having an olivine structure, one or more of lithium iron phosphate, lithium manganese phosphate, lithium cobalt phosphate, and lithium iron manganese phosphate can be used. Note that the composition formula can be represented by LiM2PO₄ (M2 is one or more selected from iron, manganese, and cobalt), and a coefficient of the composition formula is not limited to an integer.

Furthermore, composite oxide having a spinel structure, e.g., LiMn₂O₄, can be used.

### [Electrolyte]

An example of an electrolyte is described below. As one mode of the electrolyte, a liquid electrolyte (also referred to as an electrolyte solution) containing an organic solvent and an electrolyte dissolved in the organic solvent can be used. The electrolyte is not limited to a liquid electrolyte that is liquid at normal temperature or room temperature (25° C.), and a solid electrolyte can be used as well. Alternatively, an electrolyte including both an electrolyte solution that is liquid at normal temperature and a solid electrolyte that is a solid at normal temperature (such an electrolyte is referred to as a semi-solid electrolyte) can also be used. Note that when the solid electrolyte or the semi-solid electrolyte is used for a bendable battery cell, part of a stack in the battery cell includes the electrolyte, whereby the battery cell can maintain the flexibility.

In the case where an electrolyte solution is used for a flexible battery, as the organic solvent, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio, for example.

Alternatively, the use of one or more of ionic liquids (normal temperature molten salts) which have features of non-flammability and non-volatility as a solvent of the electrolyte solution can prevent a flexible battery from exploding or catching fire even when an internal region of a flexible battery shorts out or the temperature in the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The flexible battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion, for example.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, or the like can be used, for example.

For example, an organic solvent described in this embodiment contains ethylene carbonate (EC), ethyl methyl carbonate (EMC), and dimethyl carbonate (DMC). When the total content of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is x:y:100−x−y (where 5≤×≤35 and 0<y<65) can be used. More specifically, an organic solvent containing EC, EMC, and DMC at EC:EMC:DMC=30:35:35 (volume ratio) can be used.

The electrolyte solution is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

When a high-molecular material that can gel is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

### [Separator]

When the electrolyte includes an electrolyte solution, a separator is placed between the positive electrode and the negative electrode. The separator can be formed using, for example, fiber containing cellulose, such as paper, nonwoven fabric, glass fiber, ceramics, or synthetic fiber containing nylon (polyamide), polyimide vinylon (polyvinyl alcohol-based fiber), polyester, acrylic, polyolefin, or polyurethane. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a polyimide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the battery cell can be improved. When the separator is coated with the fluorine-based material, the separator is easily brought into close contact with an electrode, resulting in high output characteristics. When the separator is coated with the polyamide-based material, in particular, aramid, heat resistance can be improved to improve the safety of the battery cell.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the capacity per volume of the battery cell can be increased because the safety of the battery cell can be maintained even when the total thickness of the separator is small.

### [Exterior Body]

The battery cell includes the exterior body described in the above embodiment. In the case where a stacked-layer structure is used, the thickness of an aluminum layer used for the exterior body is preferably less than or equal to 50 μm, further preferably less than or equal to 40 μm, still further preferably less than or equal to 30 μm, yet still further preferably less than or equal to 20 μm. Note that in the case where the thickness of the aluminum layer is smaller than 10 μm, a gas barrier property might be lowered by pinholes of the aluminum layer; thus, the thickness of the aluminum layer is desirably greater than or equal to 10 μm.

This embodiment can be used in appropriate combination with any of the other embodiments.

### Embodiment 5

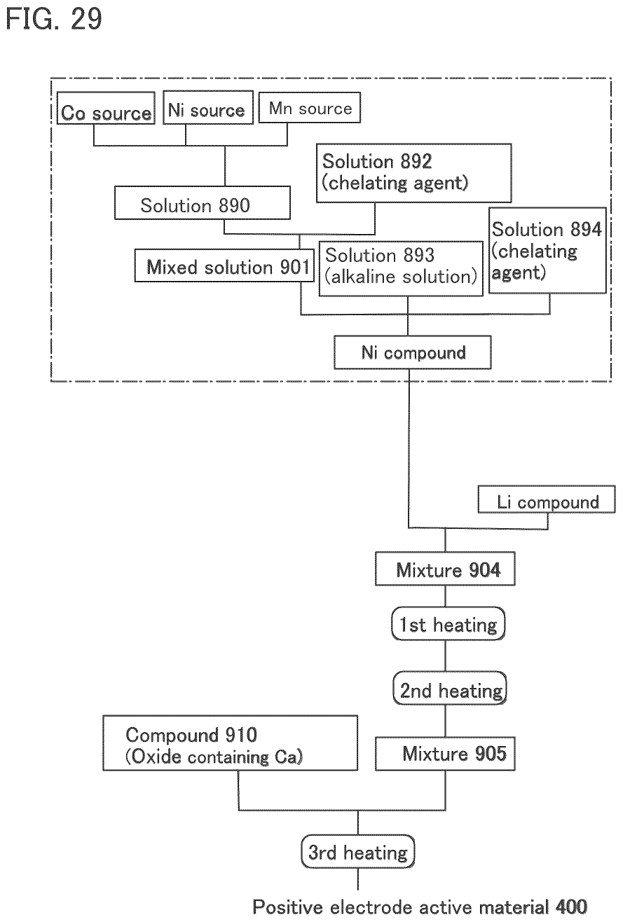

In this embodiment, a formation method 1 of a positive electrode active material that can be used for the above embodiments will be described with reference to FIG. 29. Note that the formation method 1 employs a coprecipitation method; specifically, a coprecipitation precursor where Co, Ni, and Mn exist is formed using a coprecipitation apparatus, heating is performed after the coprecipitation precursor and a Li salt are mixed, and then a calcium compound (calcium carbonate) is added and heated.

As illustrated in FIG. 29, a cobalt source, a nickel source, and a manganese source are prepared, an alkaline aqueous solution is prepared as an aqueous solution 893, and a chelating agent is prepared as an aqueous solution 892 and an aqueous solution 894. A cobalt source, a nickel source, and a manganese source are mixed to form an aqueous solution 890. The aqueous solution 890 and the aqueous solution 892 are mixed to prepare a mixed solution 901. The mixed solution 901, the aqueous solution 893, and the aqueous solution 894 are reacted with each other, so that a compound containing at least nickel, cobalt, and manganese is formed. The reaction is referred to as a neutralization reaction, an acid-base reaction, or a coprecipitation reaction in some cases; the compound containing at least nickel, cobalt, and manganese (a nickel compound in FIG. 29) is referred to as a precursor of a nickel-cobalt-manganese compound in some cases. Note that a reaction caused by performing steps surrounded by the chain line in FIG. 29 can be referred to as the coprecipitation reaction.

### <Cobalt Aqueous Solution>

A cobalt aqueous solution is prepared as the cobalt source. As the cobalt aqueous solution, an aqueous solution containing cobalt sulfate (e.g., CoSO₄), cobalt chloride (e.g., CoCl₂), cobalt nitrate (e.g., Co(NO₃)₂), cobalt acetate (e.g., C₄H₆CoO₄), cobalt alkoxide, an organocobalt complex, or hydrate of any of these is given. Alternatively, an organic acid of cobalt, such as cobalt acetate, or hydrate of the organic acid of cobalt may be used. Note that in this specification, the organic acid includes citric acid, oxalic acid, formic acid, and butyric acid, in addition to acetic acid.

An aqueous solution obtained by dissolving these in pure water can be used, for example. The cobalt aqueous solution shows acidity, and thus can be referred to as an acid aqueous solution.

### <Nickel Aqueous Solution>

A nickel aqueous solution is prepared as the nickel source. As the nickel aqueous solution, an aqueous solution of nickel sulfate, nickel chloride, nickel nitrate, or hydrate of any of these can be used. Alternatively, an aqueous solution of an organic acid salt of nickel, such as nickel acetate, or hydrate of the organic acid salt of nickel can be used. Alternatively, an aqueous solution of nickel alkoxide or an organo nickel complex can be used.

### <Manganese Aqueous Solution>

A manganese aqueous solution is prepared as the manganese source. As the manganese aqueous solution, an aqueous solution of manganese salt, such as manganese sulfate, manganese chloride, or manganese nitrate, or hydrate of any of these can be used. Alternatively, an aqueous solution of an organic acid salt of manganese, such as manganese acetate, or hydrate of the organic acid salt of manganese can be used. Alternatively, an aqueous solution of manganese alkoxide or an organomanganese complex can be used.

The above-described cobalt aqueous solution, nickel aqueous solution, and manganese aqueous solution may be prepared and mixed to form the aqueous solution 890; or nickel sulfate, cobalt sulfate, and manganese sulfate may be mixed and then mixed with water to form the aqueous solution 890, for example. In this embodiment, an aqueous solution 890 in which nickel sulfate, cobalt sulfate, and manganese sulfate are mixed with a desired amount of nickel sulfate, cobalt sulfate, and manganese sulfate is prepared.

The aqueous solution 890 and the aqueous solution 892 are mixed to prepare the mixed solution 901. As the aqueous solution 892 and the aqueous solution 894, aqueous solutions serving as chelating agents are used; however, the aqueous solution 892 and the aqueous solution 894 are not particularly limited thereto and may be pure water.

### <Alkaline Aqueous Solution>

An alkaline solution is prepared as the aqueous solution 893. Examples of the alkaline aqueous solution include an aqueous solution containing sodium hydroxide, potassium hydroxide, lithium hydroxide, or ammonia. An aqueous solution obtained by dissolving these in pure water can be used, for example. An aqueous solution in which two or more kinds selected from sodium hydroxide, potassium hydroxide, and lithium hydroxide are dissolved in pure water may be used.

### <Reaction Condition>

In the case where a reaction is caused between the mixed solution 901 and the aqueous solution 893 by the coprecipitation method, the pH of the reaction system is set to greater than or equal to 9.0 and less than or equal to 12.0, and the pH is preferably set to greater than or equal to 10.5 and less than or equal to 11.5. For example, in the case where the aqueous solution 894 is put into a reaction vessel and the mixed solution 901 and the aqueous solution 893 are dropped into the reaction vessel (also referred to as a reaction container), the pH of the aqueous solution in the reaction vessel is preferably kept in the above range. The same applies to the case where the aqueous solution 893 is put into the reaction vessel and the aqueous solution 894 and the mixed solution 901 are dropped. The same applies to the case where the mixed solution 901 is put into the reaction vessel and the aqueous solution 894 and the aqueous solution 893 are dropped. The dropping rate of the aqueous solution 893, the aqueous solution 894, or the mixed solution 901 is preferably greater than or equal to 0.1 mL/min. and less than or equal to 0.8 mL/min., in which case the pH condition can be controlled easily.

An aqueous solution in the reaction vessel is preferably stirred with a stirring means. The stirring means includes a stirrer or an agitator blade. Two to six agitator blades can be provided; for example, in the case where four agitator blades are provided, they may be placed in a cross shape seen from above. The number of rotations of the stirring means may be greater than or equal to 800 rpm and less than or equal to 1200 rpm.

The temperature in the reaction vessel is adjusted to be higher than or equal to 50° C. and lower than or equal to 90° C. The dropping of the aqueous solution 893, the aqueous solution 894, or the mixed solution 901 is started after the temperature becomes the above temperature.

The reaction vessel has an inert atmosphere. For example, in the case of a nitrogen atmosphere, a nitrogen gas is introduced at a flow rate of 0.5 L/min. or more and 2 L/min.

In the reaction vessel, a reflux condenser is placed. The nitrogen gas can be released from the reaction vessel and water can be returned to the reaction vessel with use of the reflux condenser.

Through the above reaction, a compound containing at least nickel, cobalt, and manganese is precipitated in the reaction container. Filtration is performed to collect the compound containing nickel, cobalt, and manganese. After a reaction product precipitated in the reaction vessel is washed with pure water, an organic solvent (e.g., acetone) having a low boiling point is preferably added before the filtration is performed.

The compound containing at least nickel, cobalt, and manganese after the filtration is further dried. For example, drying is performed under vacuum or reduced pressure at higher than or equal to 60° C. and lower than or equal to 120° C. for longer than or equal to 0.5 hours and shorter than or equal to 12 hours. In this manner, the compound containing nickel, cobalt, and manganese can be obtained. In FIG. 29, a compound containing nickel, cobalt, and manganese is referred to as a nickel compound.

The compound containing at least nickel, cobalt, and manganese obtained in the above reaction can be obtained as a secondary particle in which primary particles are aggregated. Note that in this specification, a primary particle refers to a particle (lump) of the smallest unit having no grain boundary when being observed, for example, at a magnification of 5000 times with a SEM (scanning electron microscope). In other words, the primary particle means a particle of the smallest unit surrounded by a grain boundary. A secondary particle refers to a particle in which the primary particles are aggregated, partially sharing the grain boundary (the circumference of the primary particle), and are not easily separated from each other (a particle independent of the other particles). That is, the secondary particle has a grain boundary in some cases.

In this embodiment, appropriate adjustment is made such that the atomic ratio of nickel, cobalt, and manganese is Ni:Co:Mn:=8:1:1 or in the neighborhood thereof in the compound containing nickel, cobalt, and manganese, which is obtained by the above coprecipitation method.

### <Lithium Compound>

Next, a lithium compound is prepared. Examples of the lithium compound include lithium hydroxide (e.g., LiOH), lithium carbonate (e.g., Li₂CO₃ (melting point: 723° C.)), and lithium nitrate (e.g., LiNO₃). In particular, a material having a low melting point among lithium compounds, typified by lithium hydroxide (melting point: 462° C.), is preferably used. Since a positive electrode active material having a high nickel proportion is likely to cause cation mixing as compared to lithium cobalt oxide, first heating needs to be performed at a low temperature. Therefore, it is preferable to use a material having a low melting point. The lithium concentration in a positive electrode active material 400 which will be described later may be adjusted as appropriate in this stage. In this embodiment, the lithium concentration is adjusted as appropriate such that the molar ratio is 1.01 with respect to the nickel compound (the compound containing nickel, cobalt, and manganese) serving as the coprecipitation precursor.

In this embodiment, the compound containing nickel, cobalt, and manganese and the lithium compound are mixed to obtain a mixture 904. For the mixing, a mortar or a stirring mixer is used.

Next, first heating is performed. An electric furnace or a rotary kiln furnace can be used as a firing device for the first heating.

The first heating temperature is preferably higher than 400° C. and lower than or equal to 1050° C. The duration of the first heating is preferably longer than or equal to 1 hour and shorter than or equal to 20 hours.

Sequentially, the particles are ground or crushed in a mortar to have a uniform particle diameter, and then collected. Furthermore, classification may be performed using a sieve. It is suitable to collect the heated materials after the materials are transferred from a crucible to the mortar in order to prevent impurities from entering the materials.

Next, second heating is performed. An electric furnace or a rotary kiln furnace can be used as a firing device for the second heating.

The second heating temperature is preferably higher than 400° C. and lower than or equal to 1050° C. The duration of the second heating is preferably longer than or equal to 1 hour and shorter than or equal to 20 hours. The second heating is preferably performed in an oxygen atmosphere, and in particular, preferably performed while oxygen is supplied. For example, the flow rate is 10 L/min. per liter of inner capacity of the furnace. Specifically, the heating is preferably performed in a state where a container containing the mixture 904 is covered with a lid.

Sequentially, the particles are ground or crushed in a mortar to have a uniform particle diameter, and then collected. Furthermore, classification may be performed using a sieve.

### <Calcium Compound>

Then, an obtained mixture 905 and a compound 910 are mixed. In this embodiment, a calcium compound is used as the compound 910. Examples of the calcium compound include calcium oxide, calcium carbonate (melting point: 825° C.), and calcium hydroxide. In this embodiment, calcium carbonate (CaCO₃) is used as the compound 910. The compound 910 desirably include calcium that is weighed in the range of 0.5 atm % to 3 atm % with respect to the compound containing nickel, cobalt, and manganese.

Then, third heating is performed. The third heating temperature is at least higher than the first heating temperature and is preferably higher than 662° C. and lower than or equal to 1050° C. The duration of the third heating is preferably shorter than that of the second heating and longer than or equal to 0.5 hour and shorter than or equal to 20 hours. The third heating is preferably performed in an oxygen atmosphere, and in particular, preferably performed while oxygen is supplied. For example, the flow rate is 10 L/min. per liter of inner capacity of the furnace. Specifically, the heating is preferably performed in a state where a container containing the mixture 905 is covered with a lid.

Sequentially, the particles are ground or crushed in a mortar to have a uniform particle diameter, and then collected. Furthermore, classification may be performed using a sieve.

Through the above steps, the positive electrode active material 400 can be formed. The positive electrode active material 400 obtained in the above steps is lithium nickel-cobalt-manganese oxide (NCM) and calcium is contained in the coating film of the primary particle or the coating film of the secondary particle.

In order to reduce the number of steps in FIG. 29, heating may be performed after a lithium compound and a calcium compound are mixed with a nickel compound serving as a coprecipitation precursor. In that case, the third heating can be omitted.

In the above-described manufacturing flow, heating after adding the calcium compound (calcium carbonate) is performed at a temperature at which the primary particle is not melted and at which calcium is not diffused in the primary particle. The lower limit temperature in the heating after adding the calcium compound (calcium carbonate) is set at a eutectic point of 662° C. When the heating at a temperature higher than or equal to 662° C. is performed after adding the calcium compound (calcium carbonate), calcium carbonate and lithium carbonate are melted and as a result, a melted substance of calcium carbonate and lithium carbonate is formed between the primary particles and calcium is diffused and dotted in the inner portion of the secondary particle. In this manner, lithium nickel-cobalt-manganese oxide to which calcium is added can be obtained. Calcium may exist in the lithium nickel-cobalt-manganese oxide, or may exist in a state of covering the lithium cobalt-manganese oxide. The state of covering the lithium cobalt-manganese oxide sometimes indicates that a coating film of the lithium cobalt-manganese oxide contains calcium.

In the above-described manufacturing flow, the step of adding the calcium compound is described; alternatively, an aluminum compound may be added instead of the calcium compound. The aluminum compound may be added in the same step as the calcium compound or may be added in forming a coprecipitation precursor. In this manner, lithium nickel-cobalt-manganese oxide to which aluminum is added can be obtained. Aluminum may exist in the lithium nickel-cobalt-manganese oxide, or may exist in a state of covering the lithium cobalt-manganese oxide. The state of covering the lithium cobalt-manganese oxide sometimes indicates that a coating film of the lithium cobalt-manganese oxide contains aluminum.

In the above-described manufacturing flow, an aluminum compound may be added instead of the calcium compound. The aluminum compound may be added in the same step as or in a step different from the calcium compound. In the latter case, the aluminum compound may be added, for example, when a coprecipitation precursor is formed.

This embodiment can be used in appropriate combination with any of the other embodiments.

### Embodiment 6

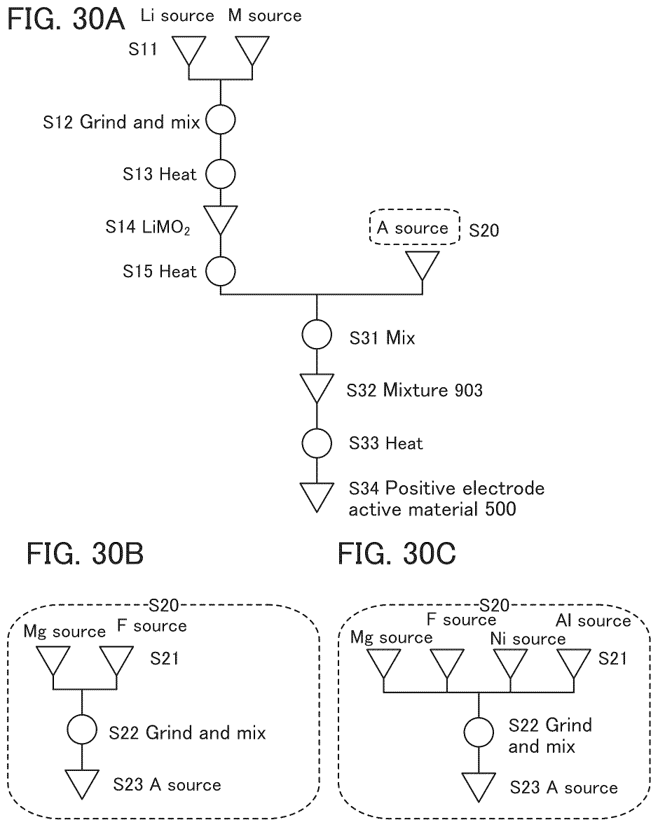

In this embodiment, a formation method 2 of a positive electrode active material that can be used for the above embodiments will be described with reference to FIG. 30A to FIG. 30C. Note that the formation method 2 employs a solid phase method; specifically, annealing and initial heating are performed.

### <Step S11>

In Step S11 shown in FIG. 30A, a lithium source (Li source) and a transition metal M source (M source) are prepared as materials for lithium and the transition metal M which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

The transition metal M can be selected from the elements belonging to Group 4 to Group 13 of the periodic table and for example, at least one of manganese, cobalt, and nickel is used. As the transition metal M, for example, cobalt alone; nickel alone; two metals of cobalt and manganese; two metals of cobalt and nickel; or three metals of cobalt, manganese, and nickel may be used. When cobalt alone is used, the positive electrode active material to be obtained contains lithium cobalt oxide (LCO); when three metals of cobalt, manganese, and nickel are used, the positive electrode active material to be obtained contains lithium nickel-cobalt-manganese oxide (NCM).

As the transition metal M source, a compound containing the above transition metal M is preferably used and for example, an oxide, a hydroxide, or the like of any of the metals given as examples of the transition metal M can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal M source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material.

Furthermore, the transition metal M source preferably has high crystallinity, and preferably includes single crystal particles, for example. The crystallinity of the transition metal M source can be judged by a TEM image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal M source.

In the case of using two or more transition metal M sources, the two or more transition metal M sources are preferably prepared to have proportions (mixing ratio) such that a layered rock-salt crystal structure would be obtained.

### <Step S12>

Next, in Step S12 shown in FIG. 30A, the lithium source and the transition metal M source are ground and mixed to form a mixed material. The grinding and mixing can be performed by a dry method or a wet method. A wet method is preferable because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal M source be mixed into dehydrated acetone whose moisture content is less than or equal to 10 ppm and which has a purity higher than or equal to 99.5% in the crushing and mixing. With the use of dehydrated acetone with the above-described purity, impurities that might be mixed can be reduced.

A ball mill, a bead mill, or the like can be used for the mixing and the like. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 30A, the above mixed material is heated. The heating temperature is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the transition metal M source. An excessively high temperature might lead to a defect due to evaporation of lithium from the lithium source and/or excessive reduction of the metal used as the transition metal M source, for example. The defect is, for example, an oxygen defect which could be induced by a change of trivalent cobalt into divalent cobalt due to excessive reduction, in the case where cobalt is used as the transition metal M.

When the heating time is too short, LiMO₂ is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. For example, a method in which a dry air is continuously introduced into a reaction chamber is employed. In that case, the flow rate of a dry air is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible or a saggar used at the time of the heating is preferably made of a highly heat-resistant material such as alumina (aluminum oxide), mullite cordierite, magnesia, or zirconia. Since aluminum oxide is a material which impurities are less likely to enter, the purity of a crucible or a saggar made of alumina is higher than or equal to 99%, preferably higher than or equal to 99.5%. In this embodiment, a crucible made of aluminum oxide with a purity of 99.9% is used. The heating is preferably performed with the crucible or the saggar covered with a lid. This can prevent volatilization of a material.

The heated material is ground as needed and may be made to pass through a sieve. Before collection of the heated material, the material may be moved from the crucible to a mortar. As the mortar, a mortar made of aluminum oxide or zirconium oxide is suitably used. A mortar made of aluminum oxide has a material property that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, a composite oxide containing the transition metal M (LiMO₂) can be obtained in Step S14 shown in FIG. 30A. The composite oxide needs to have a crystal structure of a lithium composite oxide represented by LiMO₂, but the composition is not strictly limited to Li:M:O=1:1:2. In the case where cobalt is used as the transition metal M, the composite oxide is referred to as a composite oxide containing cobalt and is represented by LiCoO₂. The composition is not strictly limited to Li:Co:O=1:1:2.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, in Step S15 shown in FIG. 30A, the above composite oxide is heated. The heating in Step S15 is the first heating performed on the composite oxide, and thus is sometimes referred to as the initial heating. The heating is performed before Step S20 described below, and thus is sometimes referred to as preheating or pretreatment.

By the initial heating, lithium is extracted from part of a surface portion of the composite oxide as described above. In addition, an effect of increasing the crystallinity of an inner portion can be expected. The lithium source and/or transition metal M prepared in Step S11 and the like might contain impurities. The initial heating can reduce impurities in the composite oxide completed in Step 14.

Through the initial heating, an effect of smoothing the surface of the composite oxide is obtained. Having a smooth surface refers to a state where the composite oxide has little unevenness and is rounded as a whole and its corner portion is rounded. A smooth surface also refers to a surface to which few foreign matters are attached. Foreign matters are deemed to cause projections and depressions and are preferably not attached to a surface.

For the initial heating, there is no need to prepare a lithium compound source. Alternatively, there is no need to prepare an additive element A source. Alternatively, there is no need to prepare a material functioning as a fusing agent.

When the heating time in this step is too short, a sufficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the inner portion is, for example, an effect of reducing distortion, a shift, or the like derived from differential shrinkage or the like of the composite oxide formed in Step S13.

The heating in Step S13 might cause a temperature difference between the surface and the inner portion of the above composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth through Step S15. This is also rephrased as modification of the surface. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 reduces the shift in a crystal or the like which is caused in the composite oxide to make the surface of the composite oxide smooth.

In a flexible battery including a composite oxide with a smooth surface as a positive electrode active material, deterioration by charging and discharging is suppressed and a crack in the positive electrode active material can be prevented.

It can be said that when surface unevenness information in one cross section of a composite oxide is quantified with measurement data, a smooth surface of the composite oxide has a surface roughness at least less than or equal to 10 nm. The one cross section is, for example, a cross section obtained in scanning transmission electron microscope (STEM) observation.

Note that in Step S14, a composite oxide containing lithium, the transition metal M, and oxygen, synthesized in advance may be used. In this case, Step S11 to Step S13 can be omitted. When Step S15 is performed on the pre-synthesized composite oxide, a composite oxide with a smooth surface can be obtained.

The initial heating might reduce lithium in the composite oxide. The additive element A described for Step S20 or the like below might easily enter the composite oxide owing to the reduction in lithium.

### <Step S20>

The additive element A may be added to the composite oxide having a smooth surface as long as a layered rock-salt crystal structure can be obtained. When the additive element A is added to the composite oxide having a smooth surface, the additive element A can be uniformly added. It is thus preferable that the initial heating precede the addition of the additive element A. The step of adding the additive element A is described with reference to FIG. 30B and FIG. 30C.

### <Step S21>

In Step S21 shown in FIG. 30B, the additive element A sources (A sources) to be added to the composite oxide are prepared. A lithium source may be prepared together with the additive

As the additive element A, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or more selected from bromine and beryllium can also be used. Note that the additive elements given earlier are more suitably used since bromine and beryllium are elements having toxicity to living things.

When magnesium is selected as the additive element A, the additive element A source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element A, the additive element A source can be referred to as a fluorine source. As the fluorine source, for example, lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride, sodium aluminum hexafluoride, or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used as the lithium source. Another example of the lithium source that can be used in Step S21 is lithium carbonate.

The fluorine source may be a gas, and fluorine, carbon fluoride, sulfur fluoride, oxygen fluoride, or the like may be used and mixed in the atmosphere in a heating step described later. Two or more of these fluorine sources may be used.

In this embodiment, lithium fluoride is prepared as the fluorine source, and magnesium fluoride is prepared as the fluorine source and the magnesium source. When lithium fluoride and magnesium fluoride are mixed at LiF:MgF₂=approximately 65:35 (molar ratio), the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride is preferably LiF:MgF₂=x:1 (0≤×≤1.9), further preferably LiF:MgF₂=x:1 (0.1≤×≤0.5), still further preferably LiF:MgF₂=x:1 (x=0.33 and the neighborhood thereof). Note that in this specification and the like, the neighborhood means a value greater than 0.9 times and less than 1.1 times a given value.

Meanwhile, magnesium is preferably added at greater than 0.1 at % and less than or equal to 3 at %, further preferably greater than or equal to 0.5 at % and less than or equal to 2 at %, still further preferably greater than or equal to 0.5 at % and less than or equal to 1 at %, relative to LiCoO₂. When magnesium is added at less than or equal to 0.1 at %, the initial discharge capacity is high but repeated charging and discharging with a large charge depth rapidly lowers the discharge capacity. In the case where magnesium is added at greater than 0.1 at % and less than or equal to 3 at %, both the initial discharge characteristics and charge and discharge cycle performance are excellent even when charging and discharging with a large charge depth are repeated. By contrast, in the case where magnesium is added at greater than 3 at %, both the initial discharge capacity and the charge and discharge cycle performance tend to gradually degrade.

### <Step S22>

Next, in Step S22 shown in FIG. 30B, the magnesium source and the fluorine source are ground and mixed. Any of the conditions for the grinding and mixing that are described for Step S12 can be selected to perform this step.

A heating step may be performed after Step S22 as needed. Any of the heating conditions described for Step S13 can be selected to perform the heating step. The heating time is preferably longer than or equal to 2 hours and the heating temperature is preferably higher than or equal to 800° C. and lower than or equal to 1100° C.

### <Step S23>

Next, in Step S23 shown in FIG. 30B, the materials ground and mixed in the above step are collected to give the additive element A source (A source). Note that the additive element A source shown in Step S23 contains a plurality of starting materials and can be referred to as a mixture.

As for the particle diameter of the mixture, the median diameter (D50) is preferably greater than or equal to 600 nm and less than or equal to 20 μm, further preferably greater than or equal to 1 μm and less than or equal to 10 μm. Also when one kind of material is used as the additive element A source, the median diameter (D50) is preferably greater than or equal to 600 nm and less than or equal to 20 μm, further preferably greater than or equal to 1 μm and less than or equal to 10 μm.

Such a pulverized mixture (which may contain only one kind of the additive element A) is easily attached to the surface of a composite oxide uniformly in a later step of mixing with the composite oxide. The mixture is preferably attached uniformly to the surface of the composite oxide, in which case fluorine and magnesium are easily distributed or dispersed uniformly in a surface portion of the composite oxide after heating. The region where fluorine and magnesium are distributed can be referred to as a surface portion. When there is a region containing neither fluorine nor magnesium in the surface portion, an 03′ type crystal structure might be unlikely to be obtained in a charged state. Note that although fluorine is used in the above description, chlorine may be used instead of fluorine, and a general term “halogen” for these elements can replace “fluorine”.

### <Step S21>

A process different from that in FIG. 30B is described with reference to FIG. 30C. In Step S21 shown in FIG. 30C, four kinds of additive element A sources to be added to the composite oxide are prepared. In other words, FIG. 30C is different from FIG. 30B in the kinds of the additive element A sources. A lithium source may be prepared together with the additive element A sources.

As the four kinds of additive element A sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 30B. As a nickel source, nickel oxide, nickel hydroxide, or the like can be used. As an aluminum source, aluminum oxide, aluminum hydroxide, or the like can be used.

### <Step S22> and <Step S23>

Step S22 and Step S23 shown in FIG. 30C are similar to the steps described with reference to FIG. 30B.

### <Step S31>

Next, in Step S31 shown in FIG. 30A, the composite oxide and the additive element A source (A source) are mixed. The ratio of the number M of the transition metal atoms in the composite oxide containing lithium, the transition metal M, and oxygen to the number Mg of magnesium atoms contained in the additive element A is preferably M:Mg=100:y (0.1≤y≤6), further preferably M:Mg=100:y (0.3≤y≤3).

The conditions of the mixing in Step S31 are preferably milder than those of the mixing in Step S12 in order not to damage the composite oxide. For example, conditions with a lower rotation frequency or shorter time than those for the mixing in Step S12 are preferable. In addition, it can be said that a dry method has a milder condition than a wet method. For example, a ball mill or a bead mill can be used for the mixing. When the ball mill is used, a ball made of zirconium oxide is preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 30A, the materials mixed in the above step are collected, whereby a mixture 903 is obtained. At the time of the collection, the materials may be crushed as needed and made to pass through a sieve.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal M source in Step S11, i.e., at the stage of the starting materials of the composite oxide. Then, the heating in Step S13 is performed, so that LiMO₂ to which magnesium and fluorine are added can be obtained. In this case, there is no need to separately perform Step S11 to Step S14 and Step S21 to Step S23. This method can be regarded as being simple and highly productive.

Alternatively, a composite oxide to which magnesium and fluorine are added in advance may be used. When a composite oxide to which magnesium and fluorine are added is used, Step S1i to Step S32 and Step S20 can be skipped. This method can be regarded as being simple and highly productive.

Alternatively, to the composite oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. 30A, the mixture 903 is heated. Any of the heating conditions described for Step S13 can be selected to perform this step. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element A source proceeds. The temperature at which the reaction proceeds is the temperature at which interdiffusion of the elements contained in LiMO₂ and the additive element A source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LIMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably higher than that in Step 13.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a flux in some cases. Owing to this function, the heating temperature can be lower than the decomposition temperature of the composite oxide (LiMO₂), e.g., a temperature higher than or equal to 742° C. and lower than or equal to 950° C., which allows distribution of the additive element A such as magnesium in the surface portion and fabrication of the positive electrode active material having favorable characteristics.

However, since LiF in a gas phase has a specific gravity less than that of oxygen, heating might volatilize LiF and in that case, LiF in the mixture 903 decreases. As a result, the function of a fusing agent deteriorates. Therefore, heating needs to be performed while volatilization of LiF is inhibited. Note that even when LiF is not used as the fluorine source or the like, Li at the surface of LiMO₂ and F of the fluorine source might react to produce LiF, which might be volatilized. Therefore, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the mixtures 903 are not adhered to each other. Adhesion of the mixtures 903 during the heating might decrease the area of contact with oxygen in the atmosphere and inhibit a path of diffusion of the additive element A (e.g., fluorine), thereby hindering distribution of the additive element A (e.g., magnesium and fluorine) in the surface portion.

It is considered that uniform distribution of the additive element A (e.g., fluorine) in the surface portion leads to a smooth positive electrode active material with little unevenness. Thus, it is preferable that the mixtures 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause volatilization of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions such as the heating temperature and the size and composition of LiMO₂ in Step S14. In the case where LiMO₂ is small, the heating is preferably performed at a lower temperature or for a shorter time than heating in the case where LiMO₂ is large, in some cases.

When the median diameter (D50) of the composite oxide (LIMO₂) in Step S14 in FIG. 30A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than or equal to 10 hours and shorter than or equal to 50 hours.

When the median diameter (D50) of the composite oxide (LIMO₂) in Step S14 is approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than or equal to 10 hours and shorter than or equal to 50 hours.

### <Step S34>

Next, in Step S34 shown in FIG. 30A, the heated material is collected and crushing is performed as needed; thus, a positive electrode active material 500 is obtained. Here, the collected positive electrode active material 500 is preferably made to pass through a sieve. Through the above steps, the positive electrode active material 500 of one embodiment of the present invention can be fabricated. The positive electrode active material of one embodiment of the present invention has a smooth surface.

This embodiment can be used in appropriate combination with any of the other embodiments.

### Embodiment 7

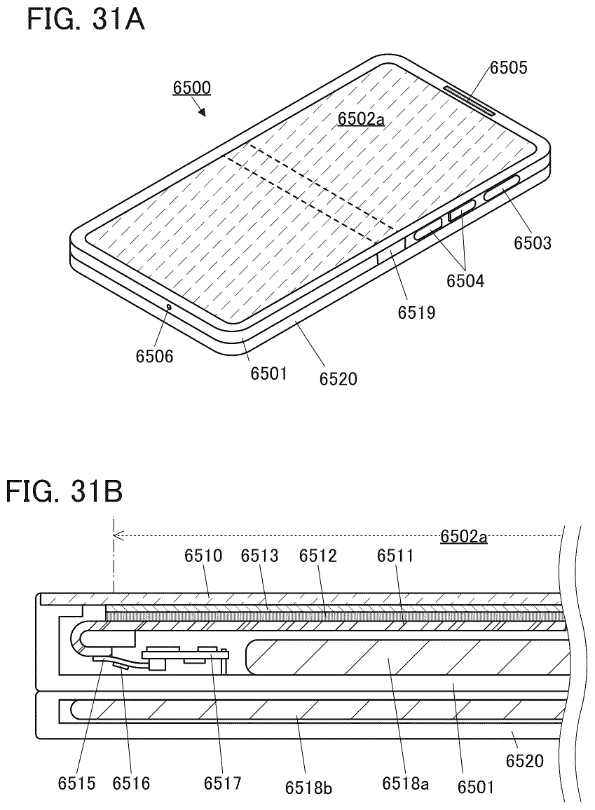

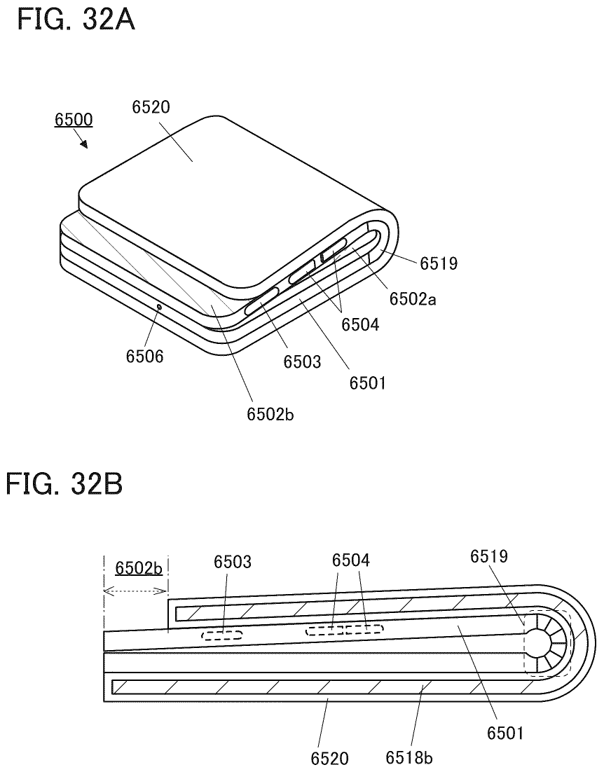

In this embodiment, an electronic device of one embodiment of the present invention will be described with reference to FIG. 31 and FIG. 32.

An electronic device 6500 illustrated in FIG. 31A is a portable information terminal that can be used as a smartphone.

The electronic device 6500 includes at least a housing 6501, a display portion 6502, a power button 6503, buttons 6504, a speaker 6505, and a microphone 6506. A display portion 6502a has a touch panel function.

The electronic device 6500 can be folded at a hinge portion 6519.

FIG. 31B is a schematic cross-sectional view including an end portion of the housing 6501 on the microphone 6506 side.

A protection member 6510 having a light-transmitting property is provided on the display surface side of the housing 6501, and a display panel 6511, an optical member 6512, a touch sensor panel 6513, a printed circuit board 6517, and a first battery 6518a are provided in a space surrounded by the housing 6501 and the protection member 6510.

The display panel 6511, the optical member 6512, and the touch sensor panel 6513 are fixed to the protection member 6510 with an adhesive layer (not illustrated).

Part of the display panel 6511 is folded back in a region outside the display portion 6502a, and an FPC 6515 is connected to the part that is folded back. An IC 6516 is mounted on the FPC 6515. The FPC 6515 is connected to a terminal provided on the printed circuit board 6517.

A flexible display can be used as the display panel 6511. The flexible display includes a plurality of flexible films and employs a plurality of light-emitting elements arranged in a matrix.

As the light-emitting elements, EL elements (also referred to as EL devices) such as OLEDs or QLEDs are preferably used. Examples of a light-emitting substance contained in the EL element include a substance that emits fluorescent light (a fluorescent material), a substance that emits phosphorescent light (a phosphorescent material), and a substance exhibiting thermally activated delayed fluorescence (a thermally activated delayed fluorescent (TADF) material). As the light-emitting substance contained in the EL element, not only an organic compound but also an inorganic compound (a quantum dot material or the like) can be used. An LED such as a micro LED can also be used as the light-emitting element.

The use of the flexible display allows an internal space of the housing 6501 to be effectively utilized and an extremely lightweight electronic device to be achieved. Since the display panel 6511 is extremely thin, the first battery 6518a with high capacity can be mounted while the thickness of the electronic device is reduced.

Furthermore, in the electronic device 6500 using the high capacity battery, a second battery 6518b is provided inside a cover portion 6520 and is electrically connected to the first battery 6518a although the connection portion therebetween is not illustrated. The flexible battery of one embodiment of the present invention can be used as the second battery 6518b.

Part of the display panel 6511 is folded back such that a connection portion with the FPC 6515 is provided on the rear side of the pixel portion, whereby an electronic device with a narrow bezel can be achieved.

When the flexible battery of one embodiment of the present invention is used as one or both of the first battery 6518a and the second battery 6518b, the electronic device 6500 can be partly folded to be downsized, so that the electronic device 6500 with high portability can be achieved.

FIG. 32A is a perspective view illustrating a folded state along the dotted line portion in FIG. 31A. The electronic device 6500 can be folded in half, the display portion 6502a and the second battery 6518b can be folded repeatedly.

FIG. 32A illustrates a structure in which a second display portion 6502b is provided in a portion exposed when the cover portion 6520 slides by folding. Even when the cover portion 6520 is folded in half, a user can check simple time display or e-mail reception notification display by seeing the second display portion 6502b.

FIG. 32B schematically illustrates a cross-sectional state of the cover portion in a state where the electronic device 6500 is folded. In FIG. 32B, the inside of the housing 6501 is not illustrated for simplicity.

In FIG. 32B, the hinge portion 6519 can be referred to as a connection portion and can have various modes as well as a structure example in which a plurality of columnar bodies are connected. It is particularly preferable that the hinge portion 6519 have a mechanism capable of bending the display portion 6502a and the second battery 6518b without stretching.

Although the second battery 6518b is illustrated inside the cover portion 6520, a plurality of second batteries may be included. In addition, a charging control circuit or a wireless charging circuit of the second battery 6518b may be provided inside the cover portion 6520.

In the example, the cover portion 6520 is partly fixed to the housing 6501 and is not fixed to a portion overlapping with the hinge portion 6519 and a portion overlapping with the second display portion 6502b that is exposed when the cover portion 6520 slides by folding.

The cover portion 6520 is not necessarily fixed to the housing 6501 and may be detachable. In the case where high capacity is not needed, the electronic device 6500 can be used while the cover portion 6520 is detached and the first battery 6518a is used. Charging of the detached second battery 6518b allows supplementary charging of the first battery 6518a when the second battery 6518b is reconnected to the first battery 6518a. Thus, the cover portion 6520 can also be used as a mobile battery.

FIG. 32A and FIG. 32B illustrate an example in which the display portion 6502a is folded in half such that the display surface faces inside; however, there is no particular limitation and the hinge portion 6519 may have a structure allowing the display portion 6502a to be folded in half such that the display surface faces outside.

The flexible battery of one embodiment of the present invention has high reliability with respect to repetitive deformation, and thus can be suitably used for the device that can be folded (also referred to as a foldable device).

At least part of this embodiment can be implemented in combination with the other embodiments described in this specification as appropriate.

### Embodiment 8

In this embodiment, examples of electronic devices each including the flexible battery of one embodiment of the present invention will be described. Examples of electronic devices each including a flexible battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines. Examples of the portable information terminals include laptop personal computers, tablet terminals, e-book readers, and mobile phones.

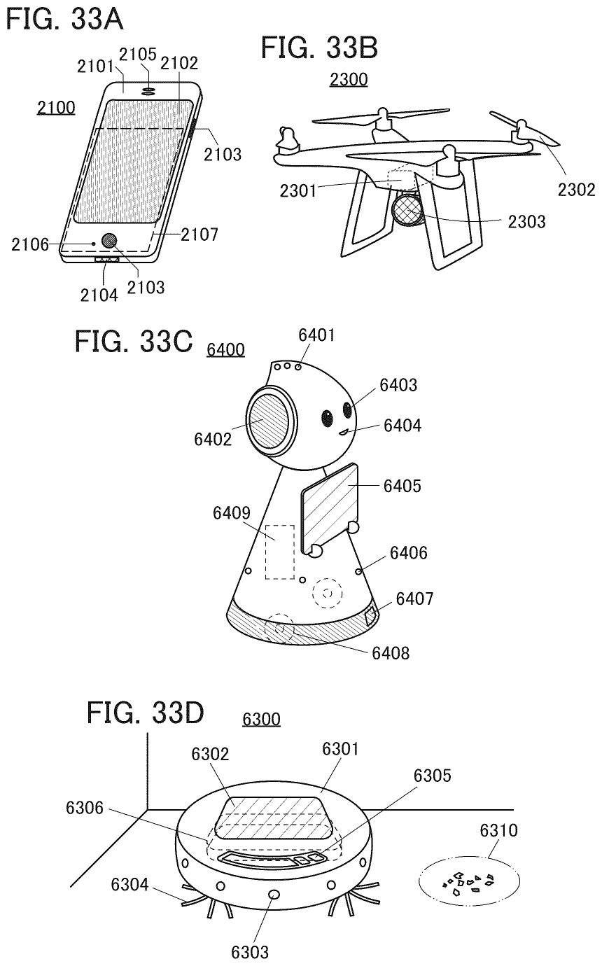

FIG. 33A shows an example of a mobile phone. A mobile phone 2100 is provided with a display portion 2102 incorporated in a housing 2101, operation buttons 2103, an external connection port 2104, a speaker 2105, a microphone 2106, and the like. Note that the mobile phone 2100 includes a flexible battery 2107 of one embodiment of the present invention. The flexible battery 2107 can be bent and thus can be mounted in a curved region of the mobile phone 2100.

The mobile phone 2100 is capable of executing a variety of applications such as mobile phone calls, e-mailing, viewing and editing texts, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and can perform direct data transmission and reception with another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 33B illustrates an unmanned aircraft 2300 including a plurality of rotors 2302. The unmanned aircraft 2300 is sometimes also referred to as a drone. The unmanned aircraft 2300 includes a flexible battery 2301 of one embodiment of the present invention, a camera 2303, and an antenna (not illustrated). The unmanned aircraft 2300 can be remotely controlled through the antenna. The flexible battery 2301 can be bent and thus can be mounted in a curved region of the unmanned aircraft 2300.

FIG. 33C illustrates an example of a robot. A robot 6400 illustrated in FIG. 33C includes a flexible battery 6409 of one embodiment of the present invention, an illuminance sensor 6401, a microphone 6402, an upper camera 6403, a speaker 6404, a display portion 6405, a lower camera 6406, an obstacle sensor 6407, a moving mechanism 6408, an arithmetic device, and the like. The flexible battery 6409 can be bent and thus can be mounted in a curved region of the robot 6400.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the flexible battery 6409 of one embodiment of the present invention and a semiconductor device or an electronic component.

FIG. 33D illustrates an example of a cleaning robot. A cleaning robot 6300 includes a display portion 6302 placed on atop surface of a housing 6301, a plurality of cameras 6303 placed on a side surface of the housing 6301, a brush 6304, operation buttons 6305, a flexible battery 6306 of one embodiment of the present invention, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface. The flexible battery 6306 can be bent and thus can be mounted in a curved region of the cleaning robot 6300.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the flexible battery 6306 of one embodiment of the present invention and a semiconductor device or an electronic component.

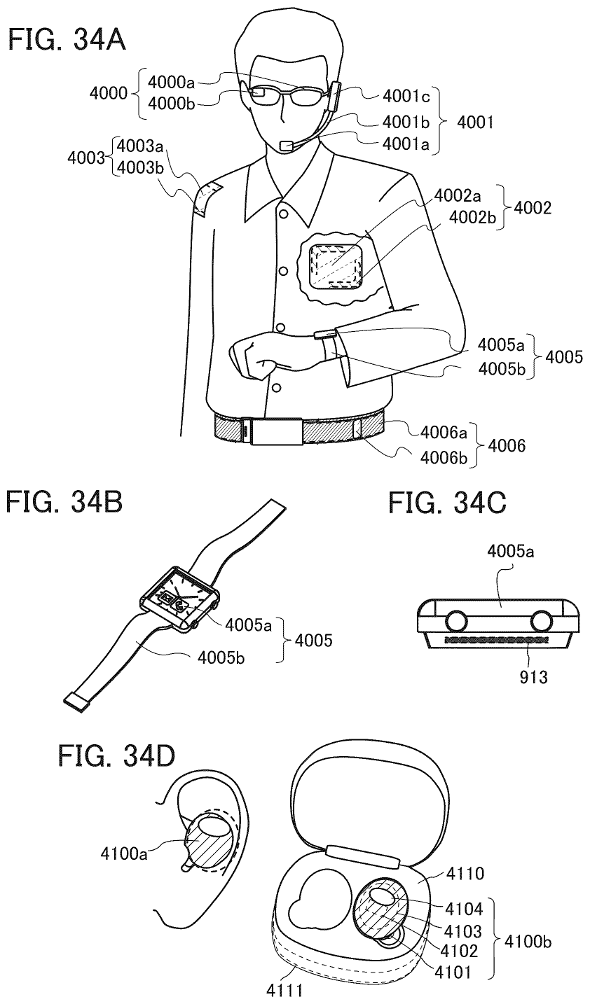

FIG. 34A illustrates examples of wearable devices. A flexible battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the flexible battery of one embodiment of the present invention can be mounted in a glasses-type device 4000 illustrated in FIG. 34A. The glasses-type device 4000 includes a frame 4000a and a display portion 4000b. The flexible battery is mounted in a temple portion of the frame 4000a having a curved shape, whereby the glasses-type device 4000 can be lightweight, can have a well-balanced weight, and can be used continuously for a long time. The flexible battery can be bent and mounted in a curved portion.

The flexible battery of one embodiment of the present invention can be mounted in a headset-type device 4001. The headset-type device 4001 includes at least a microphone portion 4001a, a flexible pipe 4001b, and an earphone portion 4001c. The flexible battery can be provided in the flexible pipe 4001b or the earphone portion 4001c. The flexible battery can be bent and mounted in a curved portion.

The flexible battery of one embodiment of the present invention can be mounted in a device 4002 that can be attached directly to a body. A flexible battery 4002b can be provided in a thin housing 4002a of the device 4002. The flexible battery can be bent and mounted in a curved portion.

The flexible battery of one embodiment of the present invention can be mounted in a device 4003 that can be attached to clothes. A flexible battery 4003b can be provided in a thin housing 4003a of the device 4003. The flexible battery can be bent and mounted in a curved portion.

The flexible battery of one embodiment of the present invention can be mounted in a belt-type device 4006. The belt-type device 4006 includes a belt portion 4006a and a wireless power feeding and receiving portion 4006b, and the flexible battery can be mounted in the inner region of the belt portion 4006a. The flexible battery can be bent and mounted in a curved portion.

The flexible battery of one embodiment of the present invention can be mounted in a watch-type device 4005. The watch-type device 4005 includes a display portion 4005a and a belt portion 4005b, and the flexible battery can be provided in the display portion 4005a or the belt portion 4005b. The flexible battery can be bent and mounted in a curved portion.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be mounted therein. Data on the exercise quantity and health of the user can be stored to be used for health maintenance.

FIG. 34B illustrates a perspective view of the watch-type device 4005 that is detached from an arm.

FIG. 34C illustrates a side view. FIG. 34C illustrates a state where a flexible battery 913 of one embodiment of the present invention is incorporated in the inner region. The flexible battery 913 is provided at a position overlapping with the display portion 4005a, can have high density and high capacity, and is small and lightweight. The flexible battery 913 can be bent and mounted in a curved portion.

FIG. 34D illustrates an example of wireless earphones. The wireless earphones illustrated here include, but are not limited to, a pair of main bodies 4100a and 4100b.

The main bodies 4100a and 4100b each include a driver unit 4101, an antenna 4102, and a flexible battery 4103 of one embodiment of the present invention. A display portion 4104 may also be included. Moreover, a substrate where a circuit such as a wireless IC is provided, a terminal for charge, and the like are preferably included. Furthermore, a microphone may be included. The flexible battery 4103 can be bent and mounted in a curved portion.

A case 4110 includes a flexible battery 4111 of one embodiment of the present invention. Moreover, a substrate where a circuit such as a wireless IC or a charge control IC is provided, and a terminal for charge are preferably included. Furthermore, a display portion, a button, and the like may be included. The flexible battery 4111 can be bent and mounted in a curved portion.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The flexible battery 4103 included in the main body 4100a can be charged by the flexible battery 4111 included in the case 4110. The flexible battery 4111 and the flexible battery 4103 can be bent and mounted in a curved portion.

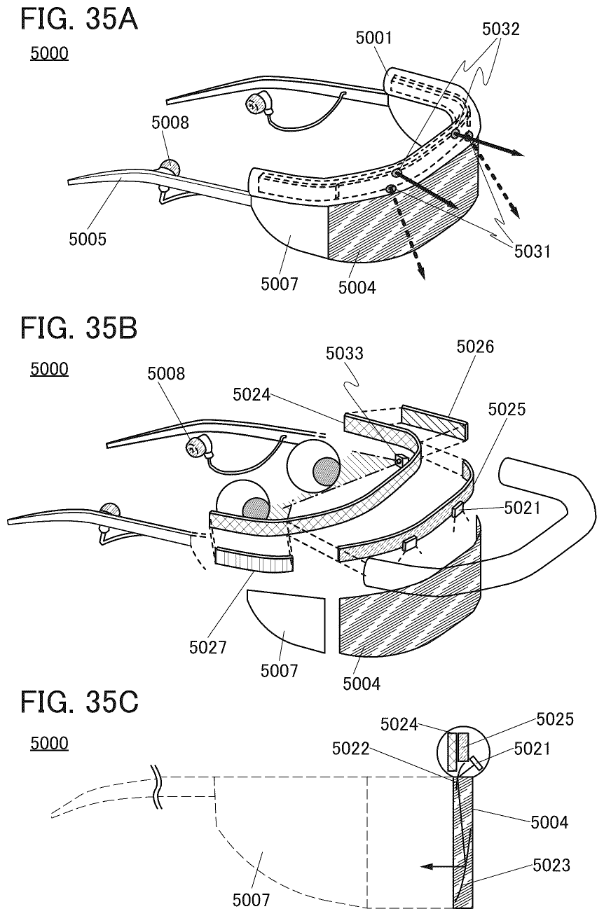

FIG. 35A to FIG. 35C illustrate another example of the glasses-type device. FIG. 35A is a perspective view of a glasses-type device 5000.

The glasses-type device 5000 has a function of what is called a portable information terminal and can execute a variety of programs and reproduce a variety of content when connected to the Internet, for example. For example, the glasses-type device 5000 has a function of displaying augmented reality content in the AR mode. The glasses-type device 5000 may have a function of displaying virtual reality content in the VR mode. Note that the glasses-type device 5000 may also have a function of displaying substitutional reality (SR) content or mixed reality (MR) contents, in addition to AR and VR content.

The glasses-type device 5000 includes a housing 5001, an optical member 5004, a wearing tool 5005, a light-blocking unit 5007, and the like. The housing 5001 preferably has a cylindrical shape. The glasses-type device 5000 is preferably wearable on the user's head. Further preferably, the glasses-type device 5000 is worn such that the housing 5001 is positioned above the circumference of the user's head passing through eyebrows and ears. When the housing 5001 has a cylindrical shape that is curved along the user's head, the glasses-type device 5000 can fit more snugly. The housing 5001 is fixed to the optical member 5004. The optical member 5004 is fixed to the wearing tool 5005 with the light-blocking unit 5007 or the housing 5001 therebetween.

The glasses-type device 5000 includes a display device 5021, a reflective plate 5022, a flexible battery 5024 of one embodiment of the present invention, and a system unit. Each of the display device 5021, the reflective plate 5022, the flexible battery 5024, and the system unit is preferably provided inside the housing 5001. The system unit can be provided with a control unit, a memory unit, and a communication unit included in the glasses-type device 5000, a sensor, and the like. The system unit is preferably provided with a charging circuit, a power supply circuit, and the like. The flexible battery 5024 can be bent and mounted in a curved portion.

FIG. 35B illustrates components included in the glasses-type device 5000 in FIG. 35A. FIG. 35B is a schematic view illustrating details of the components included in the glasses-type device 5000 illustrated in FIG. 35A.

In the glasses-type device 5000 illustrated in FIG. 35B, the flexible battery 5024 of one embodiment of the present invention, a system unit 5026, and a system unit 5027 are provided along the cylindrical housing 5001. A system unit 5025 is provided along the flexible battery 5024 and the like.

The housing 5001 preferably has a curved cylindrical shape. When the flexible battery 5024 is provided along the curved cylinder, the flexible battery 5024 can be provided efficiently in the housing 5001 and the space in the housing 5001 can be used efficiently; as a result, the volume of the flexible battery 5024 can be increased in some cases.

The housing 5001 has a cylindrical shape and the axis of the cylinder is along a part of a substantially elliptical shape, for example. A cross section of the cylinder is preferably substantially elliptical, for example. Alternatively, a part of a cross section of the cylinder preferably has a part of an elliptical shape, for example. In particular, in the case where the glasses-type device 5000 is worn on a head, the part of the cross section having a part of an elliptical shape is preferably positioned on a side facing the head. Note that one embodiment of the present invention is not limited thereto. For example, a part of a cross section of the cylinder may have a polygonal (e.g., triangular, quadrangular, or pentagonal) part.

The housing 5001 is formed so as to be curved along the user's forehead, for example. Alternatively, the housing 5001 is positioned along the user's forehead, for example.

The housing 5001 may be formed using two or more cases in combination. For example, the housing 5001 may be formed using an upper case and a lower case in combination. Alternatively, the housing 5001 may be formed using a case on an inner side (a side in contact with the user) and a case on an outer side in combination, for example. The housing 5001 may be formed using three or more cases in combination.

An electrode can be provided in a portion of the housing 5001 in contact with the user's forehead to measure brain waves using the electrode. Alternatively, an electrode may be provided in a portion in contact with the user's forehead to acquire information such as user's sweat using the electrode.

A plurality of flexible batteries 5024 may be provided inside the housing 5001.

The flexible battery 5024 can be provided along the curved cylinder, which is preferable. The flexible battery has flexibility, and thus can be positioned inside the housing more freely. The flexible battery 5024, a system unit, and the like are provided inside the cylindrical housing. The system unit is provided over a plurality of circuit boards, for example. The plurality of circuit boards and the flexible battery are connected using a connecter, a wiring, and the like. The flexible battery has flexibility, and thus can be positioned so as not to overlap with a connector, a wiring, and the like.

Note that the flexible battery 5024 may be provided, for example, inside the wearing tool 5005 as well as inside the housing 5001.

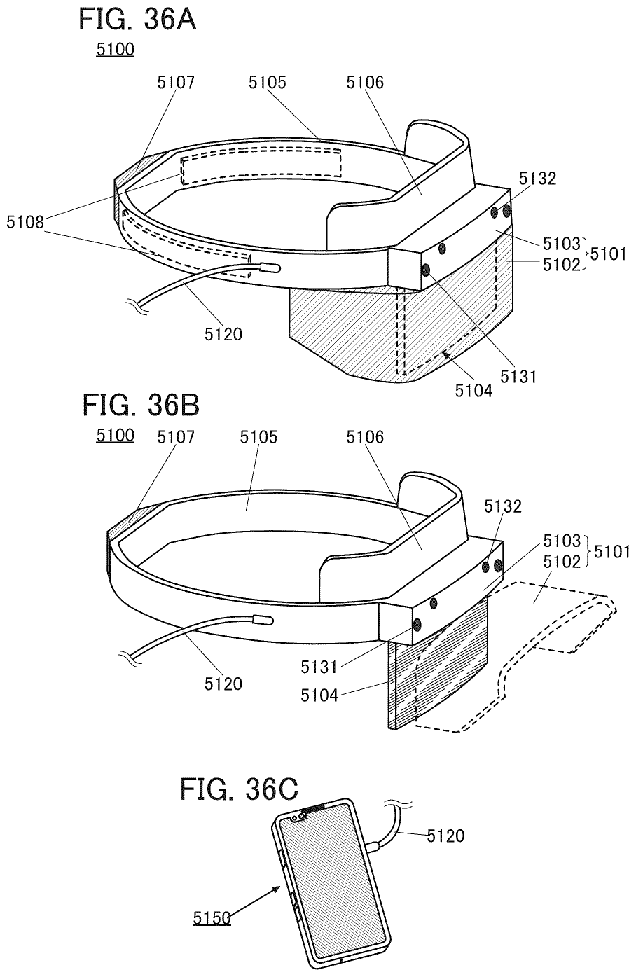

FIG. 36A to FIG. 36C illustrate an example of a head-mounted device. FIG. 36A and FIG. 36B illustrate a head-mounted device 5100 including a wearing tool 5105 with a band-like shape. The head-mounted device 5100 is connected to a terminal 5150 illustrated in FIG. 36C through a cable 5120.

FIG. 36A illustrates a first portion 5102 in a closed state, and FIG. 36B illustrates the first portion 5102 in an opened state. The first portion 5102 has a shape that covers not only the front but also the side of the face in the closed state. Accordingly, the user's view can be blocked from external light, so that realistic sensation and the sense of immersion can be increased. For example, it is also possible to increase user's sense of fear depending on content to be displayed.

In the electronic device illustrated in FIG. 36A and FIG. 36B, the wearing tool 5105 has a band-like shape. Accordingly, the electronic device is less likely to slip as compared with the structure illustrated in FIG. 36A and the like and thus is preferable in enjoying content with relatively large momentum, such as an attraction.

A flexible battery 5107 or the like of one embodiment of the present invention may be incorporated on the rear head side of the wearing tool 5105. Finding a balance between the weight of the housing 5101 on the front head side and the weight of the flexible battery 5107 on the rear head side can adjust the center of gravity of the head-mounted device 5100, whereby the device can be worn more comfortably.

A flexible battery 5108 of one embodiment of the present invention may be provided inside the wearing tool 5105 with a band-like shape. FIG. 36A illustrates an example in which two flexible batteries 5108 are provided inside the wearing tool 5105. The flexible battery having flexibility is preferably used, in which case the flexible battery can have a curved band shape.

The wearing tool 5105 includes a portion 5106 covering the user's forehead or front head. Owing to the portion 5106, the wearing tool 5105 is less likely to slip. An electrode can be provided in the portion 5106 or a portion of the housing 5101 in contact with the user's forehead to measure brain waves using the electrode.

This embodiment can be implemented in appropriate combination with the other embodiments.

### REFERENCE NUMERALS

100 flexible battery
101: negative electrode, 102: current collector, 103: active material layer, 105: material containing carbon, 131: positive electrode, 132: current collector, 133: active material layer

1. A flexible battery comprising a negative electrode and a positive electrode,
wherein the negative electrode comprises a first material containing carbon, a first current collector, and a negative electrode active material formed in the first current collector,
wherein the first material containing carbon wraps the first current collector and the negative electrode active material,
wherein the positive electrode comprises a second material containing carbon, a second current collector, and a positive electrode active material formed in the second current collector, and
wherein the second material containing carbon wraps the second current collector and the positive electrode active material.

2. A flexible battery comprising a negative electrode and a positive electrode,
wherein the negative electrode comprises a first material containing carbon, a first current collector, a second current collector positioned in an opening portion of the first current collector, and a negative electrode active material formed in the first current collector and the second current collector,
wherein the first material containing carbon wraps the first current collector, the second current collector, and the negative electrode active material,
wherein the positive electrode comprises a second material containing carbon, a third current collector, a fourth current collector positioned in an opening portion of the third current collector, and a positive electrode active material formed in the third current collector and the fourth current collector, and
wherein the second material containing carbon wraps the third current collector, the fourth current collector, and the positive electrode active material.

3. The flexible battery according to claim 2, wherein the second current collector and the fourth current collector are provided to overlap with a curved region.

4. The flexible battery according to claim 1, wherein each of the first material containing carbon and the second material containing carbon has a bag-like shape or a cylindrical shape.

5. The flexible battery according to claim 1, wherein each of the first material containing carbon and the second material containing carbon comprises a graphene compound.

6. The flexible battery according to claim 5, wherein the graphene compound is graphene oxide.

7. The flexible battery according to claim 5, wherein the graphene compound is reduced graphene.

8. The flexible battery according to claim 1, wherein each of the first material containing carbon and the second material containing carbon comprises graphene.

9. The flexible battery according to claim 1, wherein each of the first material containing carbon and the second material containing carbon comprises carbon fiber.

10. The flexible battery according to claim 1, wherein a separator is provided between the negative electrode and the positive electrode.

11. The flexible battery according to claim 10, wherein the separator has a bag-like shape or a cylindrical shape.

12. The flexible battery according to claim 1, wherein a separator is not provided between the negative electrode and the positive electrode.

13. The flexible battery according to claim 1, wherein an area of the positive electrode is smaller than an area of the negative electrode.

14. The flexible battery according to claim 1, wherein a median diameter (D50) of the negative electrode active material or the positive electrode active material is greater than or equal to 10 nm and less than or equal to 30 μm.

15. The flexible battery according to claim 1,
wherein the positive electrode active material comprises a secondary particle, and
wherein a median diameter (D50) of a primary particle included in the secondary particle is greater than or equal to 10 nm and less than or equal to 1 μm.

16. An electronic device comprising the flexible battery according to claim 1.

17. The flexible battery according to claim 2, wherein each of the first material containing carbon and the second material containing carbon has a bag-like shape or a cylindrical shape.

18. The flexible battery according to claim 2, wherein each of the first material containing carbon and the second material containing carbon comprises a graphene compound.

19. The flexible battery according to claim 18, wherein the graphene compound is graphene oxide.

20. The flexible battery according to claim 5, wherein the graphene compound is reduced graphene.

21. The flexible battery according to claim 2, wherein each of the first material containing carbon and the second material containing carbon comprises graphene.

22. The flexible battery according to claim 2, wherein each of the first material containing carbon and the second material containing carbon comprises carbon fiber.
